(19) United States
(12) Patent Application Publication
(10) Pub. No.: US 2003/0153992 A1
(43) Pub. Date: Aug. 14, 2003

(54) Information processing device, information processing system, information processing method, and information processing program

(76) Inventors: Hiroyuki Maruyama, Kanagawa (JP); Yoshihiro Yamaguchi, Tokyo (JP); Chikako Kido, Kanagawa (JP); Maiko Nakane, Kanagawa (JP); Kazunori Okino, Kanagawa (JP); Yoshihiro Chosokabe, Nagano (JP)

Correspondence Address: FROMMER LAWRENCE & HAUG, 745 FIFTH AVENUE- 10TH FL., NEW YORK, NY, 10151, US

(21) Appl. No.: 10/268,283

(22) Filed: Oct. 10, 2002

(30) Foreign Application Priority Data
Oct. 11, 2001 (JP) 2001-314546

(51) Int. Cl. G05B 15/00; G09G 5/00

(52) U.S. Cl. 700/83; 345/716

(57) ABSTRACT

An information processing device which enables a user to intuitively operate basic operations of even a jog dial-unsupportable application is provided. When a jog dial-unsupportable application program is started, a jog dial server refers to a jog script and first displays, in a jog dial window, items related to basic operations of the jog dial-unsupportable application program that can be associated with operations based on a jog dial.

### BACKGROUND OF THE INVENTION

1. Field of the Invention

This invention relates to an information processing device, an information processing system, an information processing method and an information processing program for carrying out processing based on an input operation by a user using an input device to carry out rotation or turn and press operations.

2. Description of the Related Art

Recently, in order to improve the user-friendliness of portable information processing devices themselves the user-friendliness of application softwares, for example, a device having a rotation/press-type operating unit called jog dial provided on a lateral side of its body has already been made commercially available by the present Assignee. The jog dial is provided on one of the left and right lateral sides of the body and is rotatable in forward and backward directions and can be pressed down with respect to an axial line set in the up-and-down direction.

As one use of the jog dial in a personal computer, for example, selection from a plurality of items of application software displayed on a display screen is carried out in a scroll-like manner by using forward and backward rotation of the jog dial, and by pressing down the jog dial in the state where application software is selected, the selected application software is executed. Mechanical changes of such a jog dial due to its operations basically include three-dimensional elements, that is, rotations in the two directions and pressing down. In addition to these, the quantity of rotation in each direction, and the rotational speed in each direction of rotation calculated from the quantity of rotation can be obtained. Therefore, by associating changes accompanied by operations of the jog dial with specific functions of the information processing device itself or various functions in application software, the user-friendliness can be significantly improved.

State transition in an application corresponding to operations of the jog dial is tuned on the application side by using a jog dial application interface.

An application called jog dial-supportable application in which the state transition is tuned by using the jog dial application interface, and an application called jog dial-unsupportable application in which the state transition is not tuned, are distinguished.

Meanwhile, a jog dial-supportable application only emulates, from outside, controls which are generally considered to be provided in all applications. It cannot associate the jog dial with characteristic operations of media reproduction such as increase/decrease in volume and selection of a tune provided in an audio reproduction application.

Conventionally, when an application is started, though easy operations based on the jog dial is demanded, the first graphical user interface that is displayed on the display screen does not immediately show a guide operation about what can be done by operating the jog dial now.

Moreover, conventionally, in an information processing device which is remotely operated by operation means like the jog dial provided on a remote operation device, when operating an application, what can be done by what operation of the jog dial at present must be confirmed each time on the display screen though easy operation by using the remote operation device at hand is demanded. The advantages of the remote operation device cannot be fully utilized and the user must carry out troublesome operations.

### SUMMARY OF THE INVENTION

In view of the foregoing status of the art, it is an object of the present invention to provide an information processing device, an information processing method and an information processing program which enable the user to intuitively carry out basic operations of an application even with respect to a jog dial-unsupportable application.

It is another object of the present invention to provide an information processing system which enables the user to intuitively carry out basic operations of an by using a remote operation device.

An information processing device according to the present invention for starting an application program and processing various information, comprises: display means; first operation means for carrying out rotation or turn and press operations; and server means for referring to a script defined for interlocking an operation of an unsupportable application program which does not support said first operation means and an operation based on said first operation means; wherein when said unsupportable application program is started, said server means refers to said script and causes the display means to first display an item related to a basic operation of said unsupportable application program that can be associated with an operation based on said first operation means.

Another information processing device according to the present invention for selectively starting a plurality of application programs and processing various information, comprises: display means; first operation means for carrying out rotation or turn and press operations; and server means for referring to a script defined for interlocking an operation common to a plurality of unsupportable application programs of the same system which do not support with an operation of said first operation means and an operation based on said first operation means; wherein when one of said plurality of unsupportable application programs of the same system is started, said server means refers to said script and causes the display means to first display an item related to a basic operation common to said plurality of unsupportable application programs of the same system that can be associated with an operation based on said first operation means.

An information processing system according to the present invention comprises an information processing device for processing various information on the basis of an application program, and a remote operation device for sending a remote operation signal to the information processing device. Said remote operation device comprises first operation means for carrying out rotation or turn and press operations, and control means for determining an operating status of said first operation means by processing based on the program taken in from said information processing device. Said information processing device comprises server means for referring to a script defined for interlocking an operation of an unsupportable application program which does not support said first operation means and an operation based on said first operation means, said server means referring to said script when said unsupportable application program is started and causing display means to first display an item related to a basic operation of said unsupportable application program that can be associated with an operation based on said first operation means.

Another information processing system according to the present invention comprises an information processing device for selective starting a plurality of application programs and processing various information respectively, and a remote operation device for sending a remote operation signal to the information processing device. Said remote operation device comprises first operation means for carrying out rotation or turn and press operations, and control means for determining an operating status of said first operation means by processing based on the program taken in from said information processing device. Said information processing device comprises server means for referring to a script defined for interlocking an operation common to a plurality of unsupportable application programs of the same system which do not support an operation of said first operation means and an operation based on said first operation means, said server means referring to said script when one of said plurality of unsupportable application programs of the same system is started and causing display means to first display an item related to a basic operation common to said plurality of unsupportable application programs of the same system that can be associated with an operation based on said first operation means.

An information processing method according to the present invention used in an information processing device for starting an application program and processing various information, comprises: a script loading step of loading a script defined for interlocking an operation of an unsupportable application program which does not support an operation of first operation means for carrying out rotation or turn and press operations provided in said information processing device, and an operation based on said first operation means; and a display control step of, when said unsupportable application program is started, referring to the script loaded by said script loading step and causing display means to first display an item related to a basic operation of said unsupportable application program that can be associated with an operation based on said first operation means.

Another information processing method according to the present invention used in an information processing device for selectively starting a plurality of application programs and processing various information, comprises: a script loading step of loading a script defined for interlocking an operation common to a plurality of unsupportable application programs of the same system which do not support an operation of first operation means for carrying out rotation or turn and press operations provided in said information processing device, and an operation based on said first operation means; and a display control step of, when one of said plurality of unsupportable application programs of the same system is started, referring to the script loaded by said script loading step and causing display means to first display an item related to a basic operation common to said plurality of unsupportable application programs that can be associated with an operation based on said first operation means.

An information processing program according to the present invention executed in an information processing device for starting an application program and processing various information, comprises: a script loading step of loading a script defined for interlocking an operation of an unsupportable application program which does not support an operation of first operation means for carrying out rotation or turn and press operations provided in said information processing device, and an operation based on said first operation means; and a display control step of, when said unsupportable application program is started, referring to the script loaded by said script loading step and causing display means to first display an item related to a basic operation of said unsupportable application program that can be associated with an operation based on said first operation means.

Another information processing program according to the present invention executed in an information processing device for selectively starting a plurality of application programs and processing various information, comprises: a script loading step of loading a script defined for interlocking an operation common to a plurality of unsupportable application programs of the same system which do not support an operation of first operation means for carrying out rotation or turn and press operations provided in said information processing device, and an operation based on said first operation means; and a display control step of, when one of said plurality of unsupportable application programs of the same system is started, referring to the script loaded by said script loading step and causing display means to first display an item related to a basic operation common to said plurality of unsupportable application programs that can be associated with an operation based on said first operation means.

In the information processing device according to the present invention, when the unsupportable application program which does not support the first operation means for carrying out rotation or turn and press operations is started, an item related to a basic operation of the unsupportable application program is first displayed on the display means in association with an operation based on the first operation means. This enables the user to intuitively carry out the basic operation of the application.

As the information processing method and the information processing program are executed by the information processing device, when the unsupportable application program which does not support the first operation means for carrying out rotation or turn and press operations is started, an item related to a basic operation of the unsupportable application program is first displayed on the display means in association with an operation based on the first operation means. This enables the user to intuitively carry out the basic operation of the application.

In the information processing system according to the present invention, when the unsupportable application program which does not support the first operation means for carrying out rotation or turn and press operations provided in the remote operation device is started, an item related to a basic operation of the unsupportable application program is first displayed on the display means in association with an operation based on the first operation means. This enables a user to intuitively carry out the basic operation of the application.

### BRIEF DESCRIPTION OF THE DRAWINGS

FIG. 1 is a functional block diagram of an information processing device as an embodiment of the present invention.

FIG. 2 is a perspective view showing the appearance of a notebook model personal computer.

FIG. 3 is a side view showing essential parts of the notebook model personal computer.

FIG. 4 is a perspective view showing the appearance of essential parts of a jog dial.

FIG. 5 shows a part of constituent parts of the jog dial.

FIG. 6 is a cross-sectional view showing essential parts of the jog dial.

FIG. 7 is a cross-sectional view showing the jog dial.

FIG. 8 is a partial cross-sectional view showing the jog dial.

FIG. 9 is a view for explaining rotations of the jog dial.

FIG. 10 is a view for explaining pressing down of the jog dial.

FIG. 11 is a block diagram showing the electrical structure of the notebook model personal computer.

FIG. 12 is a view for explaining the operation of embedded controller of the notebook model personal computer.

FIG. 13 is a flowchart for explaining a jog dial monitor program executed by the embedded controller.

FIG. 14 is a view for explaining the operation of a rotation detecting unit of the jog dial.

FIG. 15 is a flowchart for explaining a specific example of an information processing program of the present invention executed by the notebook model personal computer.

FIG. 16 is a flowchart showing a jog dial status monitor program executed by the notebook model personal computer and an example of processing of a jog dial driver.

FIG. 17 is a state transition view for explaining a jog script which is referred to when a jog dial-unsupportable audio reproduction application is started.

FIGS. 18A to 18C show examples of GUI display based on the jog script of FIG. 17.

FIGS. 19A to 19C show conventional example of GUI display.

FIG. 20 is a state transition view for explaining a jog script which is referred to when a jog dial-unsupportable browser is started.

FIGS. 21A to 21C show examples of GUI display based on the jog script of FIG. 20.

FIG. 22 is a perspective view showing the appearance of a notebook model personal computer as a second example of the information processing device.

FIG. 23 is an enlarged view showing essential parts of the notebook model personal computer of the second example.

FIGS. 24A to 24C show examples of GUI display based on the jog script of FIG. 17 in the notebook model personal computer of the second example.

FIG. 25 shows the appearance of an information processing system as a third example of the information processing device.

FIG. 26 is a perspective view showing the appearance of a remote controller with jog dial.

FIG. 27 is a plan view of the remote controller with jog dial.

FIG. 28 shows the remote controller with jog dial, as viewed from its operating part.

FIG. 29 is a back view of the remote controller with jog dial.

FIG. 30 is a bottom view of the remote controller with jog dial.

FIG. 31 shows how the jog dial of the remote controller with jog dial is operated.

FIG. 32 shows how a shift button of the remote controller with jog dial is operated.

FIG. 33 is a block diagram showing the internal structure of the remote controller with jog dial.

FIG. 34 is a structural view of an MPU of the remote controller with jog dial.

FIG. 35 is an internal functional block diagram of a micro-controller.

FIGS. 36A and 36B show GUI when a launcher application is started in the notebook model personal computer.

FIGS. 37A and 37B show a group list and a software list in an application group setting dialog.

FIGS. 38A and 38B show confirmation screens in the application group setting dialog.

### DESCRIPTION OF THE PREFERRED EMBODIMENT

A preferred embodiment of the present invention will now be described with reference to the drawings. This embodiment is an information processing device for starting an application program in accordance with a guide displayed on a display part and processing various information.

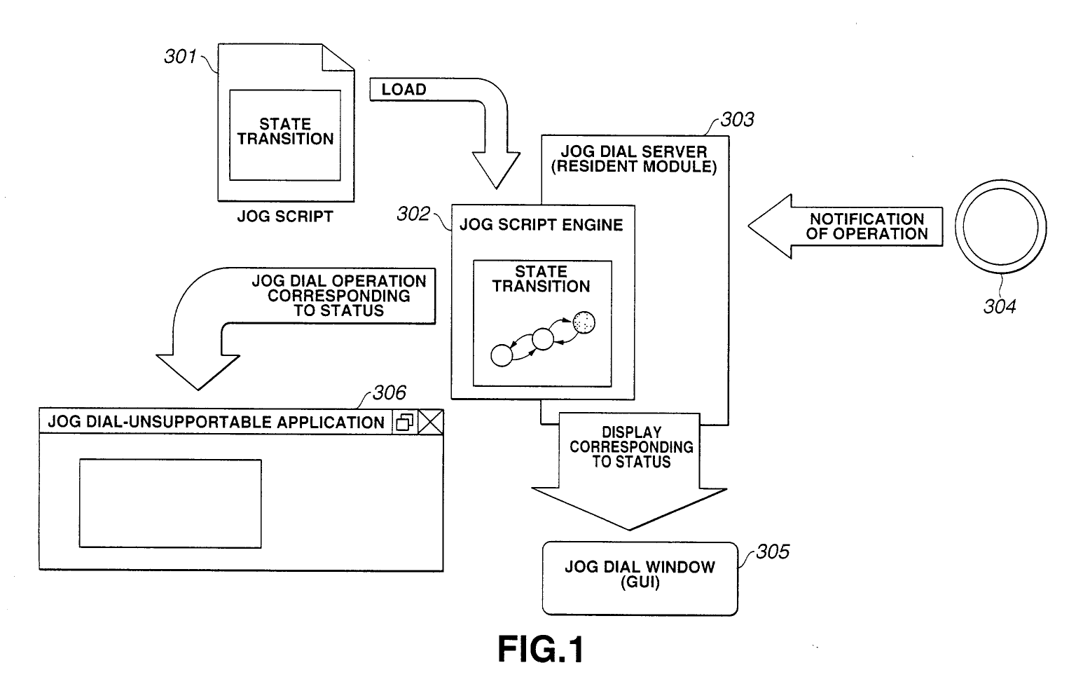

This information processing device has a jog dial 304 as first operation means for carrying out rotation or turn and press operations, as schematically shown in FIG. 1. The rotation is an operation to continuously rotate the dial in a forward or backward direction. However, some of jog dials are of such a type that the dial is turned little by little in the forward direction, for example, to advance the track one by one, or the dial is turned little by little in the backward direction to reverse the track. Therefore, the operation is referred to as rotation or turn operation here.

Generally, in the information processing device, the user-friendliness is significantly improved by associating changes accompanied by operations of the jog dial with specific functions or associating these changes with various functions in application software.

Conventionally, state transition in an application which supports operations of the jog dial is tuned on the application side by using a jog dial application interface (API). An application in which the state transition is tuned by using the jog dial application interface (API) is called jog dial-supportable application, and an application in which the state transition is not tuned is called jog dial-unsupportable application.

The information processing device shown in FIG. 1 also has a jog dial server 303 which refers to a jog script defined for interlocking operations of a jog dial-unsupportable application and operations based on the jog dial 304.

A jog script 301 is a file of an event-driven type program in which state transition of the jog dial 304 is described in a script language. In this script 301, the state transition, the contents of display in each state, and the operation of each state can be described.

The state transition shows how and in which situation each state shifts. The contents of display in each state designate whether the display status is a guide display status or a list view display status, what item string exists in the list view display status, what character string is displayed in the guide display status and so on. The guide display status is a display status where an action can be done, for example, simply by rotating the jog dial. In the case of an audio reproduction application, it is a status where actions such as selection of a tune and increase/decrease in volume can be carried out by rotation operations of the jog dial. The list view display status is a display status where the user can visually recognize a plurality of items by rotating the jog dial and select an item by pressing the jog dial.

The operation in each state is an operation which functions when the jog dial is operated in that state. The following operational function items can be described therein. The first item is keyboard input. The second item is mouse input. The third item is access to an external module. The first item of keyboard input and the second item of mouse input can be emulated or allocated to up and down keys so as to support execution of menu selection. The third item of access to an external module enables more complicated operations.

When a jog dial-unsupportable application program 306 is started, the jog dial server 303 refers to the jog script 301 and causes a jog dial window 305 to first display therein an item related to a basic operation of the jog dial-unsupportable application program that can be associated with an operation based on the jog dial 304. The jog dial server 303 also decides an operation and a display in accordance with the state transition corresponding to the description of the jog script 301. Thus, state transition due to difference in hardware can be supported simply by changing the jog script 301. Particularly in this information processing device, since state transition corresponding to the jog dial 304 can be set for each type of unsupportable application, various supports can be realized.

The information processing device shown in FIG. 1 can carry out jog dial operations exhibiting predominance of the jog dial 304 even in the jog dial-unsupportable application program 306.

Several specific example of the information processing device will now be described.

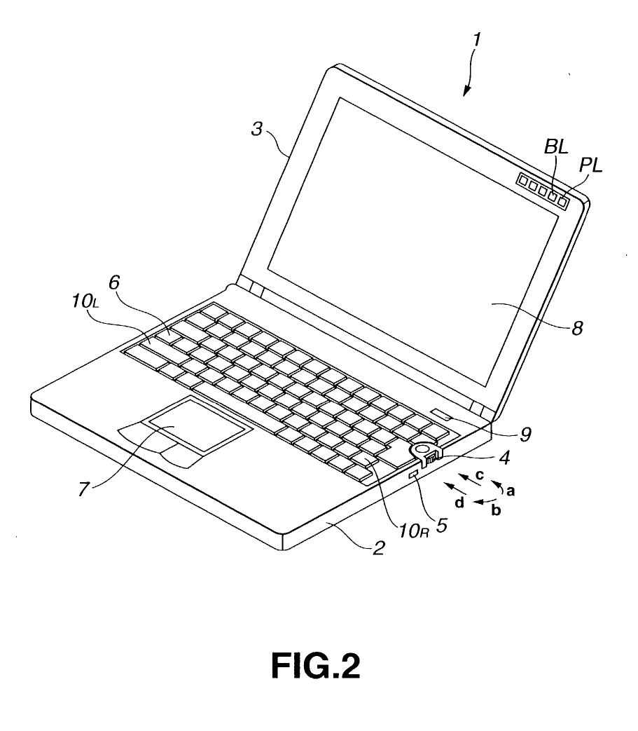

A first specific example is a notebook model personal computer 1 as shown in FIG. 2, in which a recording medium having the information processing program of the preesnt invention recorded therein is provided or loaded to execute the information processing method of the present invention.

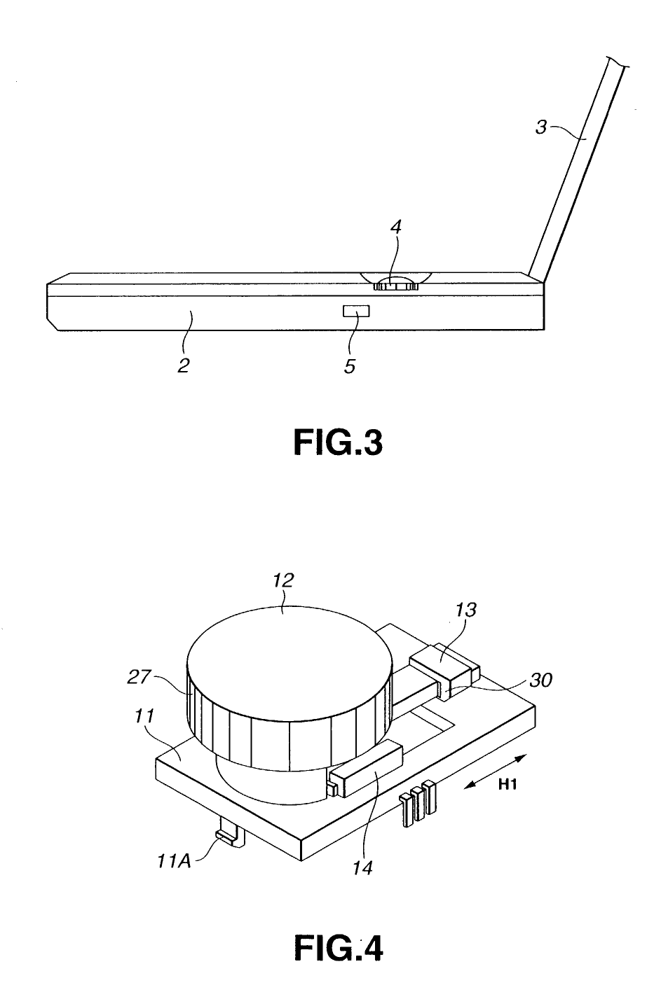

The notebook model personal computer 1 is constituted by a body 2 and a display part 3 which can open from and close on the body 2. FIG. 2 is a perspective appearance view showing the state where the display part 3 is open from the body 2. FIG. 3 is a side view showing the state where the display part 3 is open from the body 2.

A keyboard 6 operated to input various characters and symbols, a touch pad 7 as a pointing device operated to move a mouse cursor, and a power switch 9 are provided on the upper side of the body 2.

On the right side of the keyboard 6 on the body 2, a jog dial 4 (first operation means) for a rotation or turn operation and a press operation is provided. On the keyboard 6, Shift keys 10L, 10R as second operation means are arranged at positions which are substantially symmetrical in the left-and-right direction. Moreover, a back button 5 for restoring the processing which is previous to the processing corresponding to a press operation of the jog dial 4 is provided near the jog dial 4.

On the front side of the display part 3, an LCD (liquid crystal display) 8 for displaying an image is provided. Moreover, a power lamp PL, a battery lamp BL, a message lamp ML, if necessary, and other lamps made of LED are provided in the horizontal direction at an upper right corner part of the display part 3.

The jog dial 4 will now be described in detail. The jog dial 4 executes predetermined operational functions corresponding to rotation or turn operations indicated by arrows a and b in FIG. 2, and executes a predetermined operational function corresponding to a press operation indicated by an arrow c in FIG. 2. The predetermined processing carried out by the jog dial 4 differs depending on whether an application program to be executed is a jog dial-unsupportable application program or a jog dial-supportable application program, and the type of the application program. A jog dial-unsupportable application program does not support operations of the back button. On the other hand, a jog dial-supportable application program supports operations of the back button.

First, the structure of the jog dial 4 will be described. The jog dial 4 is a specific example of a rotation operation-type electronic component with push switch, disclosed in the Japanese Patent No.3222714.

Specifically, the jog dial 4 has rotary encoder part 12 and a push switch part 13 arranged on a contact mounting board 11, as shown in FIG. 4. The rotary encoder part 12 can horizontally move in a predetermined range, but the push switch part 13 is fixed so as not to be moved.

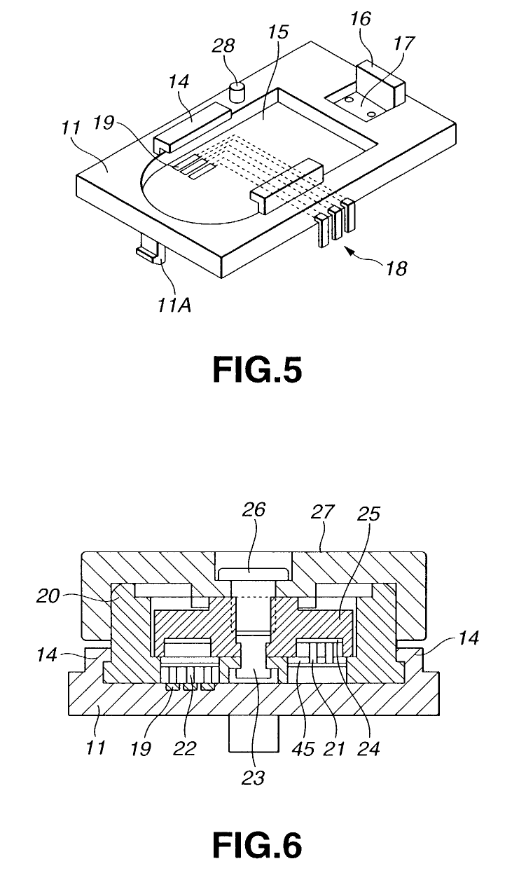

On the contact mounting board 11, a recess 15 having moving guide rail parts 14 for the rotary encoder part 12, a recess 17 having a stop wall 16 for fixing the push switch part 13, and a contact plate 19 having a terminal 18 for transmitting an electric signal of the rotary encoder part 12 to outside are provided on a flat plate-like molded resin body, as shown in FIG. 5.

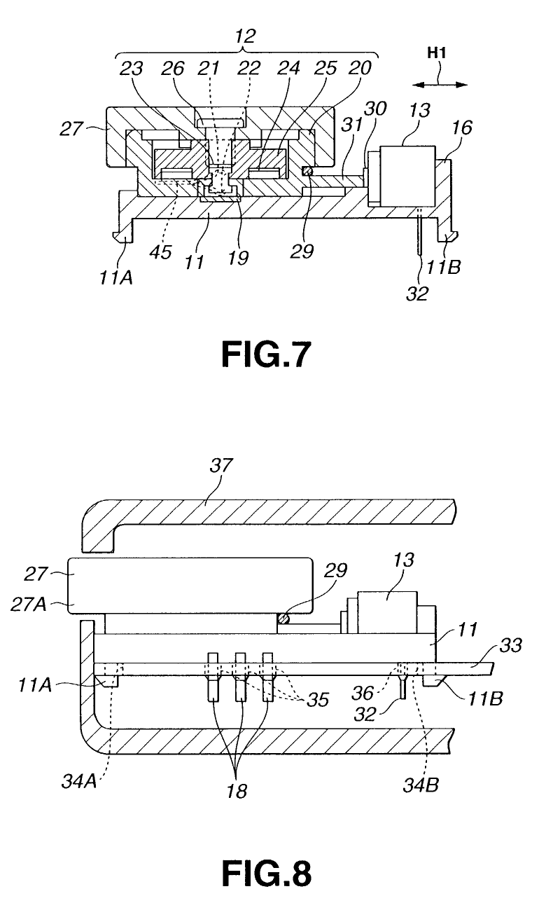

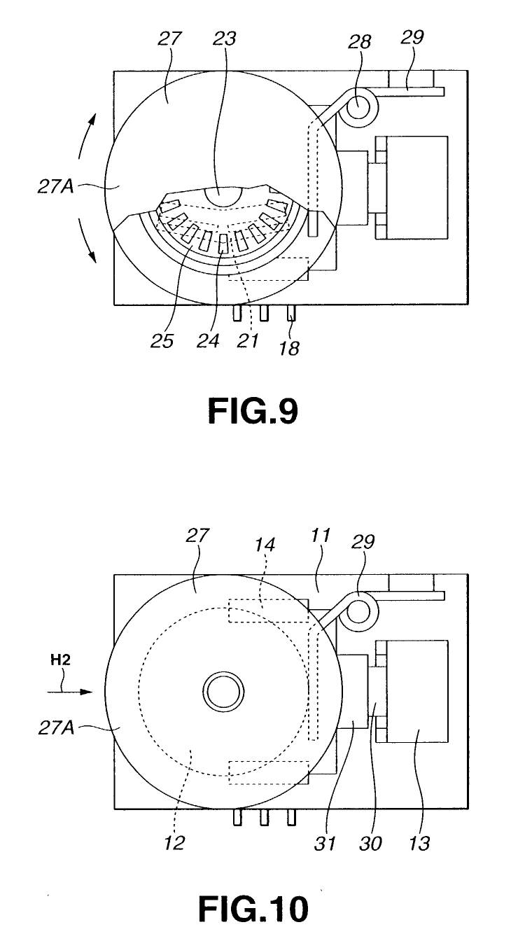

The rotary encoder part 12 is constituted by the following elements: a box-shape case 20 of molded resin which is fitted in the recess 15 of the contact mounting board 11 and is held by the guide rails 14 so as to be horizontally movable within a predetermined range (in a direction indicated by an arrow H1 shown in FIGS. 4 and 7); elastic contact legs 21, 22 protruding upward an downward from an elastic contact body 45 mounted by insertion-molding on the bottom side of the box-shaped case 20; a rotating body 25 of molded resin which is rotatably held by a columnar shaft 23 integrated at the center of the box-shaped case 20 and has a disc-shaped radial contact plate 24 with the elastic contact leg 21 elastically contacting its lower side; and a disc-shaped operating knob 27 of such a type that its outer circumference is operated, attached above the rotating body 25 by a screw 26 so as to rotate the rotating body 25, as shown in FIGS. 6 and 7. The lateral side of the box-shaped case 20 is pushed in the horizontal direction by a torsion coil spring 29 positioned by a pin-like protrusion 28 (see FIGS. 5 and 9) on the contact mounting board 11, and in an ordinary state, the rotary encoder part 12 is thus energized to be at a position away from the push switch part 13 and the elastic contact leg 22 protruding downward from the bottom side of the box-shaped case 20 elastically contacts the contact plate 19 of the contact mounting board 11.

The push switch part 13 is fitted and fixed in the recess 17 of the contact mounting board 11 so that an operating button 30 faces the rotary encoder part 12 while a rear end part is abutted against the stop wall 16, as shown in FIGS. 4 and 5.

As shown in FIG. 7, a driving protrusion 31 integrally provided on the box-shaped case 20 of the rotary encoder part 12 is abutted against the distal end of the operating button 30 of the push switch part 13. The jog dial is constituted as described above. When it is mounted on an electronic equipment, leg parts 11A, 11B on the lower side of the contact mounting board 11, the connection terminal 18 of the rotary encoder part 12, and a connection terminal 32 of the push switch part 13 are inserted and soldered for connection to mounting holes 34A, 34B, 35, 36 of a printed wiring board 33 of the equipment, and the disc-shaped knob 27 is mounted on the rotary encoder part 12 so that an end of the disc-shaped knob 27 on the side opposite to the side facing the push switch part 13 protrudes outward from a spacing in an armor case 37 of the equipment, as shown in FIG. 8.

Operations of the jog dial will now be described. First, as shown in FIGS. 8 and 9, as a tangential force is applied to rotate a protruding part 27A which protrude from the armor case 37, of the disc-shaped operating knob 27 mounted on the upper end of the rotary encoder part 12, the rotating body 25 rotates about the columnar shaft 23 at the center of the box-shaped case 20 and the upward elastic contact leg 21 elastically contact and slides on the radial contact plate 24 on the lower side of the rotating body 25. At this contact part, a pulse signal interlocked with the rotation of the disc-shaped operating knob 27 is generated.

Then, this pulse signal is transmitted from the upward elastic contact leg 21 to the downward elastic contact leg 22. The pulse signal is further transmitted to the contact plate 19 on the contact mounting board 11 which the elastic contact leg 22 elastically contacts, and then the pluse signal is transmitted to the circuit on the printed wiring board 33 of the electronic equipment via the external connection terminal 18.

As shown in FIG. 10, a pushing force in a horizontal direction (indicated by an arrow H2) connecting the center of the disc-shaped operating knob 27 and the push switch part 13 is applied to the protrusing part 27A of the disc-shaped operating knob 27 against the energizing force of the torsion coil spring 29 on the contact mounting board 11, thus moving the whole rotary encoder part 12 in the horizontal direction along the guide rail parts 14 on the contact mounting board 11. The operating button 30 is pressed by the protrusion 31 provided on the box-shaped case 20 to operate the push switch part 13. Its signal is transmitted to the circuit on the printed wiring board 33 of the electronic equipment via the connection terminal 32 shown in FIG. 8.

The pushing force applied to the disc-shaped operating knob 27 is removed, the rotary encoder part 12 is pushed back to restore the state shown in FIG. 9 by an elastic restoring force of the torsion coil spring 29 on the contact mounting board 11.

In the above description, as the means for transmitting the electric signal of the rotary encoder part 12 to the connection terminal 18 on the contact mounting board 11, the elastic contact leg 22 protruding downward from the bottom side of the box-shaped case 20 of the rotary encoder part 12 elastically contacts the contact plate 19 on the contact mounting board 11. However, the elastic contact leg may be projected from the contact mounting board 11 and elastically contact the contact plate on the bottom side of the box-shaped case 20. The foregoing is the description of the structure and operations of the jog dial 4 arranged on the right lateral side of the body 2.

The back button 5 will now be described. The back button 5 is arranged near the jog dial 4, that is, on the right lateral side of the body as shown in FIGS. 2 and 3, to restore the processing which is previous to the processing corresponding to a press operation of the jog dial 4. As the back button 5 is pressed in a direction of arrow d shown in FIG. 2, the contact is closed to generate an ON-signal. The structure of the back button 5 is not particularly characteristic and therefore will not be described in detail.

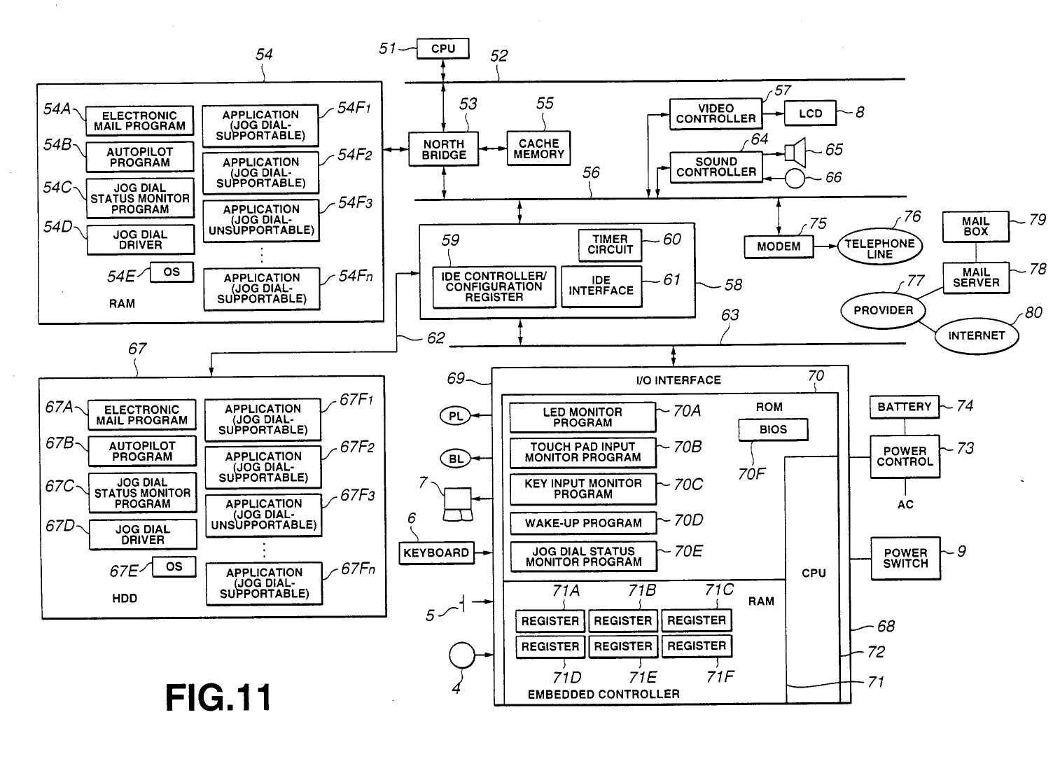

An example of the electrical structure of the notebook model personal computer 1 will now be described with reference to FIG. 11. A central processing unit (CPU) 51 is constituted by, for example, a Pentium (trademark registered) processor by Intel Corporation, and is connected to a host bus 52. A north bridge 53 is connected to the host bus 52, and the north bridge 53 is also connected to a PCI bus 56. The north bridge 53 is constituted by, for example, 400BX by Intel Corporation, and performs peripheral control of the CPU 51 and a main memory 54. The north bridge 53 and a south bridge 58, which will be described later, constitute a so-called chip set.

The north bridge 53 is further connected with the main memory 54 and a cache memory 55. The cache memory 55 is to cache data used by the CPU 51. Although not shown, a primary cache memory is provided also within the CPU 51.

The main memory 54 is constituted by, for example, a DRAM (dynamic random access memory), and stores programs to be executed by the CPU 51 and data necessary for operations of the CPU 51. Specifically, on completion of start-up, for example, an electronic mail program 54A, an autopilot program 54B, a jog dial status monitor program 54C, a jog dial driver 54D, an operating program (OS) 54E, and other application programs 54F1 to 54Fn are transferred to and stored in the main memory 54 from an HDD 67.

The electronic mail program 54A is a program for transmitting and receiving communication texts through a network from a communication channel such as a telephone line 76 via a modem 75, which will be described later. The electronic mail program 54A has a received mail acquisition function as a specific function. This received mail acquisition function is to access a mail server 78 of a provider 77 to confirm whether a mail addressed to the user is received in a mailbox 79 or not, and execute processing to acquire a mail addressed to the user if there is such a mail.

The autopilot program 54B is a program for sequentially starting and carrying out a plurality of preset processing or programs in a preset order.

The OS (operating system software) 54E is a program for controlling the basic operation of the computer, such as the so-called Windows 95 and Windows 98 (both of which are trademarks registered) by Microsoft Corporation and the so-called Mac OS (trademark registered) by Apple Computer, Inc.

The jog dial status monitor program 54C is for monitoring the operating status of the jog dial after the power switch 9 is turned on.

The jog dial driver 54D receives a notification from each application as to whether the application supports the jog dial and the back button, and operates to display what operation can be carried out by operating the jog dial 4 if the application supports the jog dial and the back button. Usually, the jog dial driver 54D is waiting for an event from the jog dial 4 and also has a list for receiving a notification from the application. The jog dial driver 54D carries out various functions in accordance with operations of the jog dial 4 and the back button 5.

The jog dial driver 54D is also a specific example of the information processing program. Specifically, when a jog dial-unsupportable application program is started, the jog dial driver 54D is executed by the CPU 51 and the CPU 51 operates as the jog dial server 303. Specifically, when a jog dial-unsupportable application program is started, the CPU 51 executes the jog dial driver 54D including the information processing program according to the present invention and operates as the jog dial server 303. Thus, the jog dial server 303 loads the jog script 301 from a predetermined storage, then sets functions which are enabled by operations of the jog dial 304 on the basis of the state transition described in the jog script 301, in association with the basic operations of the jog dial-unsupportable application program, and displays such functions in the guide display status or the list view display status.

Moreover, the information processing program of the present invention may be included in the jog dial status monitor program 54C. Specifically, when a jog dial-unsupportable application program is started, the jog dial status monitor program 54C is executed by the CPU 51 and the CPU 51 operates as the jog dial server 303. Specifically, when a jog dial-unsupportable application program is started, the CPU 51 executes the jog dial status monitor program 54C including the information processing program according to the present invention and operates as the jog dial server 303. Thus, the CPU 51 as the jog dial server 303 loads the jog script 301 from a predetermined storage, then sets functions which are enabled by operations of the jog dial 304 on the basis of the state transition described in the jog script 301, in association with the basic operations of the jog dial-unsupportable application program, and displays such functions in the guide display status or the list view display status via the jog dial driver 54D.

In the case of a jog dial-supportable application, the application side declares that the application supports the jog dial, what state transition is carried out, what display is made and how it operates, to the jog dial server 303. Therefore, the notebook model personal computer 1 does not execute the information processing method of the present invention as a program.

The description of the notebook model personal computer 1 will now be continued.

A video controller 57 is connected to the PCI bus 56 and controls the display on the LCD 8 of the display part 3 on the basis of data supplied via the PCI bus 56.

A sound controller 64 is connected to the PCI bus 56 and takes in an input from a microphone 66 or supplies an audio signal to a speaker 65. Moreover, a modem 75 is connected to the PCI bus 56. The modem 75 can be connected to a communication network 80 such as the Internet and the mail server 78 via the telephone line 76 and the Internet service provider 77.

Also the south bridge 58 is connected to the PCI bus 56. The south bridge 58 is constituted by, for example, PIIX4E by Intel Corporation, and controls various I/Os (inputs/outputs). Specifically, the south bridge 58 is constituted by an IDE (integrated device electronics) controller/configuration register 59, a timer circuit 60, an IDE interface 61 and the like, and controls the devices connected to the IDE bus 62 and the devices connected thereto via an ISA/EIO (industry standard architecture/extended input/output) bus 63 and an embedded controller 68.

The IDE controller/configuration register 59 is constituted by two IDE controllers, that is, so-called primary IDE controller and secondary IDE controller, and a configuration register (these are not shown).

The primary IDE controller is connected to a connector (not shown) via the IDE bus 62, and also the HDD 67 is connected to the connector. The secondary IDE controller is electrically connected with connectors of bay devices as IDE devices including a CD-ROM drive, a second HDD, and an FDD, not shown, when these bay devices are loaded to the secondary IDE controller via other IDE buses.

An electronic mail program 67A, an autopilot program 67B, a jog dial status monitor program 67C, a jog dial driver 67D, an OS (operating system software) 67E and a plurality of application programs 67F1 to 67Fn are stored in the HDD 67. The programs 67A, 67B, 67C, 67D, 67E, 67F1 to 67Fn in the HDD 67 are sequentially transferred and stored into the RAM 54 in the process of boot-up processing.

Moreover, the embedded controller 68 is connected to the ISA/EIO bus 63. This embedded controller 68 is made up of a microcontroller and is used as an I/O controller. The embedded controller 68 is constituted by interconnecting an I/O interface 69, a ROM 70, RAM 71 and a CPU 72.

In the ROM 70, an LED control program 70A, a touch pad input monitor program 70B, a key input monitor program 70C, a wake-up program 70D, and a jog dial status monitor program 70E are stored in advance.

The LED control program 70A is a program for controlling lighting of the power lamp PL, the battery lamp BL, and if necessary, the message lamp ML, and other lamps made of LED. The touch pad input monitor program 70B is a program for monitoring the input by the user from the touch pad 7. The key input monitor program 70C is a program for monitoring the input from the keyboard 6 and other key switches. The wake-up program 70D is a program for checking whether a preset time point has been reached or not on the basis of the present time data supplied from the timer circuit 60 in the south bridge 58, and for managing each chip power source to start predetermined processing (or program) when the preset time is reached.

The jog dial status monitor program 70E is a program for constantly monitoring whether the rotary encoder part 12 of the jog dial 4 is rotated or pressed and whether the back button 5 is pressed. The jog dial status monitor program 70E will be later described in detail.

Moreover, a BIOS 70F is written in the ROM 70. The BIOS is a basic input/output system, which is a software program for controlling transmission (input/output) of data between the OS or application software and the peripheral equipments (display, keyboard, HDD and the like).

The RAM 71 has registers for LED control, touch pad input status, key input status and preset time, and an I/O register for monitoring the jog dial status, as registers 71A to 71F. For example, the LED control register 71A controls lighting of the message lamp ML for displaying an instantaneous boot-up status of electronic mail, which will be described later, when the jog dial 4 is pressed. The key input status register 71C is adapted for storing an operation key flag when the jog dial 4 is pressed for single-touch operation, which will be described later. The preset time register 71D can arbitrarily set a certain time point.

The jog dial 4, the back button 5, the keyboard 6 and the touch pad 7 are connected to the embedded controller 68 via connectors, not shown. The embedded controller 68 outputs signals corresponding to the operations of the jog dial 4, the back button 5, the keyboard 6 and the touch pad 7, to the ISA/EIO bus 63. Also the power lamp PL, the battery lamp BL, the message lamp ML, and the other lamps made of LED are connected to the embedded controller 68.

Moreover, a power control circuit 73 is connected to the embedded controller 68. The power control circuit 73 is connected to an internal battery 74 or an AC power source. The power control circuit 73 supplies necessary power to each block and carries out control to charge the internal battery 74 and the second batteries of the peripheral devices. The embedded controller 68 also monitors the power switch 9 which is operated when turning on and off the power.

Even when the power switch 9 is off, the embedded controller 68 can execute the respective programs 70A, 70B, 70C, 70D and 70E constantly by using the internal power source. In short, these programs are constantly running, even when no windows are opened on the LCD8 of the display part 3. The embedded controller 68 is constantly executing the jog dial status monitor program 70E even when the power switch 9 is off and the OS 54E is not started on the CPU 51. Particularly, though not described in detail, the embedded controller 68 provides a programmable power key (PPK) function even without having a dedicated key on the notebook model personal computer 1, and enables the user to start up desired software or script file simply by pressing the jog dial 4, for example, in the power-saving status or when the power is off.

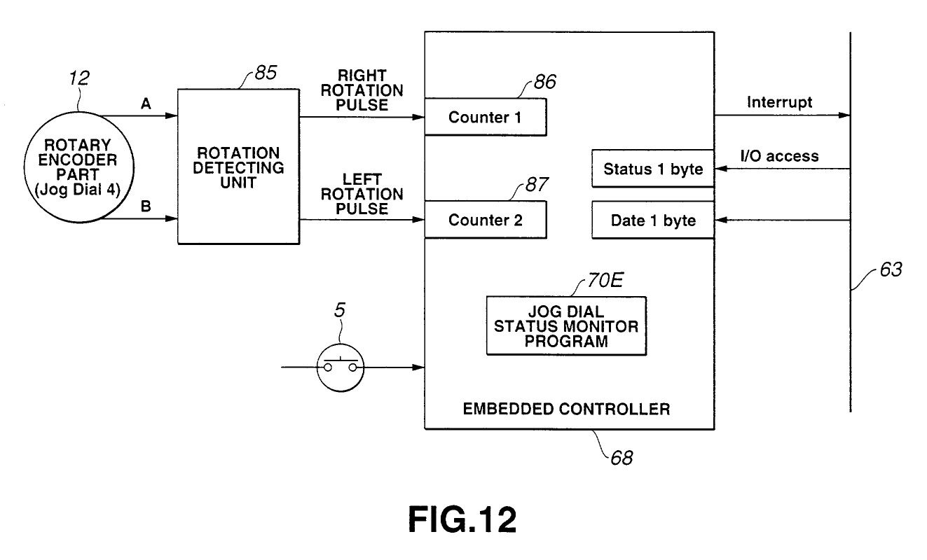

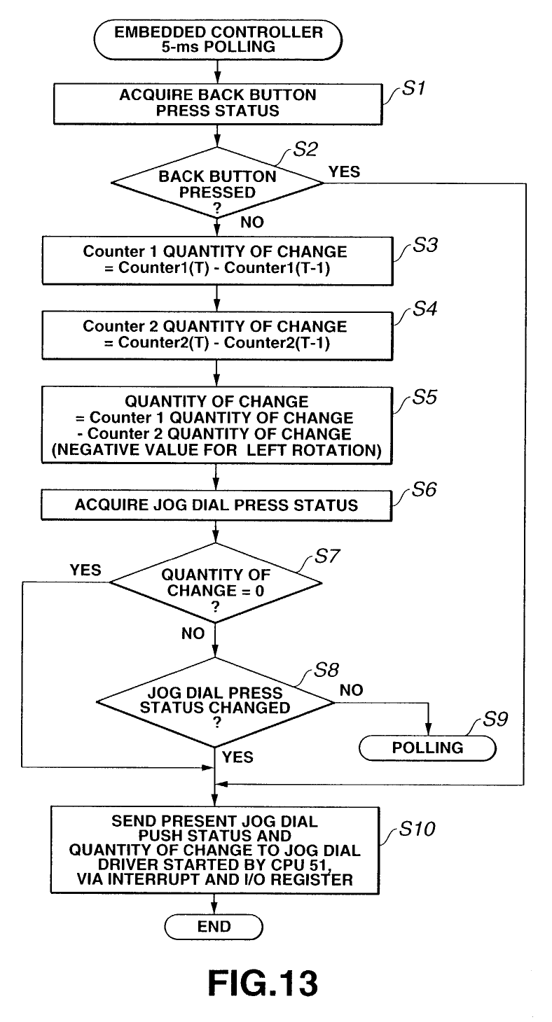

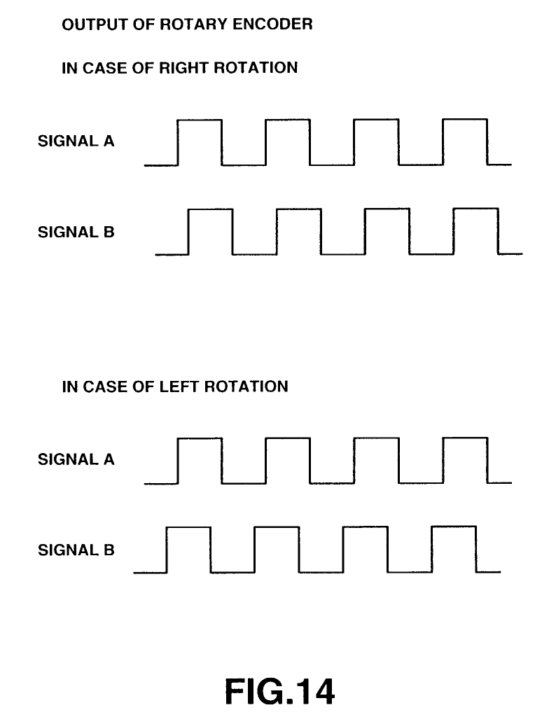

The operation of the embedded controller 68 when it executes the jog dial status monitor program 70E will now be described with reference to FIGS. 12 to 14. FIG. 12 shows the hardware structure in which the embedded controller 68 monitors the status of the rotary encoder part 12 of the jog dial 4 via a rotation detecting unit 85. The embedded controller 68 also monitors the status of the back button 5. FIG. 13 is a flowchart when the embedded controller 68 executes the jog dial status monitor program 70E. FIG. 14 is a timing chart for explaining operations of the rotation detecting unit 85 of FIG. 12.

First, the embedded controller 68 monitors whether the back button 5 is pressed or not. If not, the embedded controller 68 detects which direction the rotary encoder part 12 of the jog dial 4 is rotated, that is, left or right, via the rotation detecting unit 85. The rotation detecting unit 85 detects whether it is a right rotation or a left rotation on the basis of the timing of a signal A and a signal B shown in FIG. 14. If a right rotation is detected, the rotation detecting unit 85 supplies a right rotation pulse to a counter (1) 86 of the embedded controller 68. If a left rotation is detected, the rotation detecting unit 85 supplies a left rotation pulse to a counter (2) 87 of the embedded controller 68.

Specifically, the following operations are carried out. First, the embedded controller 68 executes the jog dial status monitor program 70E, thus acquiring the press status of the back button 5 based on 5-ms polling (step S1). If it is determined at step S2 that the back button 5 is pressed down (YES), the processing goes to step S10, which will be described later. If it is determined that the back button 5 is not pressed down (NO), the processing goes to step S3 and the subsequent steps.

At step S3, with respect to the right rotation pulse, a count value Counter1(T−1) at a time T−1 is subtracted from a counter value Counter1(T) at the present time T, thus finding a quantity of change Counter1 of the count value of the counter 86.

Next, at step S4, with respect to the left rotation pulse, a count value Counter2(T−1) at a time T−1 is subtracted from a counter value Counter2(T) at the present time T, thus finding a quantity of change Counter2 of the count value of the counter 87.

Then, at step S5, the difference in the quantity of change of the count value is calculated. That is, the difference between the quantity of change Counter1 and the quantity of change Counter2 is calculated. If this difference in the quantity of change has a negative value, it is a left rotation.

At step S6, the press status of the jog dial 4 is acquired. At step S7, the quantity of change calculated at step S5 is judged. At step S8, whether the press status of the jog dial 4 is changed or not is determined. If the quantity of change is detected at step S7, or if a change in the press status is detected at step S8, the processing goes to step S10 and the current press status of the jog dial 4 and the quantity of change are sent through the host bus 52 to the jog dial driver 54D started up by the CPU 51, by interrupt via the I/O register 71F. The processing at this step S10 is also applied to the processing of the back button 5 if it is determined at step S2 that the back button 5 is pressed. In this case, the current press status of the back button 5 is sent through the host bus 52 to the jog dial driver 54D started up by the CPU 51, by interrupt via the I/O register 71F.

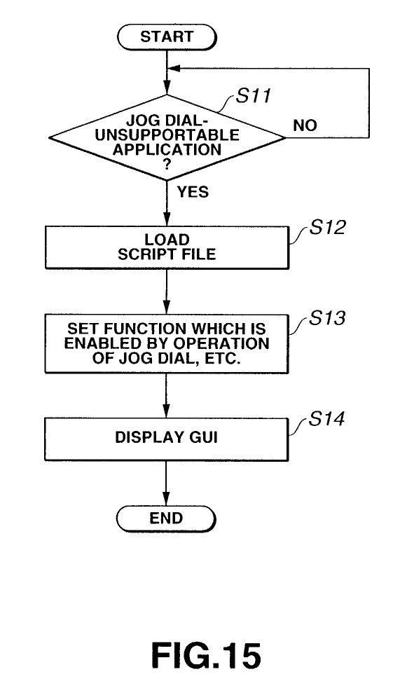

A specific example of the information processing program of the present invention executed by the CPU 51 when an application program is started in accordance with a guide on the display part after the power switch 9 is turned on, will now be described with reference to FIG. 15. This specific example constitutes a part of the jog dial driver 54D or the jog dial status monitor program 54C. As described above, the CPU 51 servers as the hog dial server 303 shown in FIG. 1 by executing a part of the jog dial driver 54D or the jog dial status monitor program 54C (specific example of the information processing program of the present invention).

First, at step S11, it is determined whether an application program to be started is jog dial-unsupportable or not. If it is jog dial-unsupportable (YES), the processing goes to step S12 and the jog dial script 301 stored in a predetermined storage, for example, the HDD 67, is loaded (step S12).

At step S13, the CPU 51 sets a function which is enabled by an operation of the jog dial 4 on the basis of the state transition described in the jog script 301, in association with the basic operation of the jog dial-unsupportable application program. Then, at step S14, for example, the guide display status is displayed on the GUI.

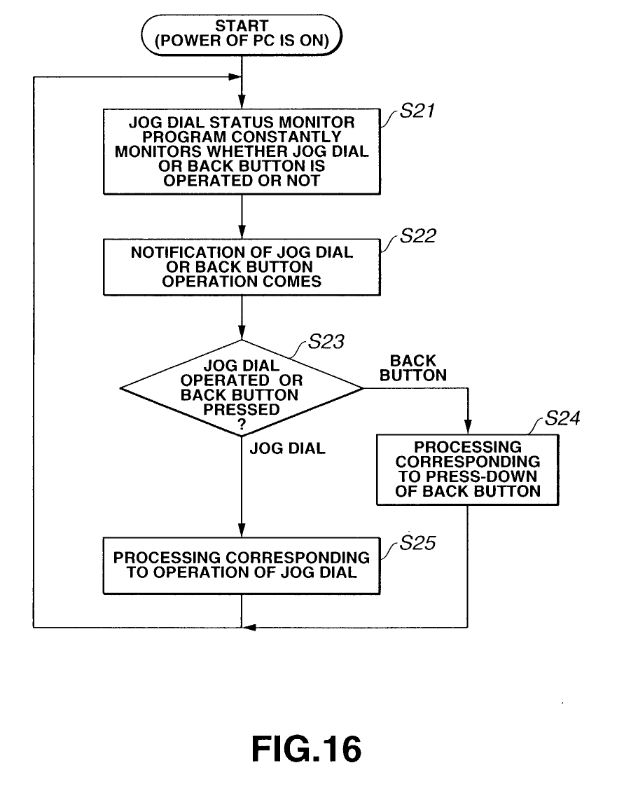

FIG. 16 shows an example of processing of the jog dial status monitor program 54C and the jog dial driver 54D executed by the CPU 51, for example, after the guide display status is displayed on the GUI 305 when the notebook model personal computer 1 starts a jog dial-unsupportable application program.

At step S21, the CPU 51 constantly monitors whether the jog dial 4 and the back button 5 are operated or not, by using the jog dial status monitor program 54C. Next, as a notification of operation is sent from the jog dial 4 or the back button 5 at step S22, the CPU 51 at step S23 determines whether the jog dial 4 is operated or whether the back button 5 is pressed.

If it is determined at step S23 that the jog dial 4 is operated, the CPU 51 executes the jog dial driver 54D and carries out processing corresponding to the operation of the jog dial 4 with reference to the script 301. On the other hand, if it is determined at step S23 that the back button 5 is pressed, the CPU 51 executes the jog dial driver 54D and carries out processing corresponding to the operation of the back button 5 with reference to the script 301.

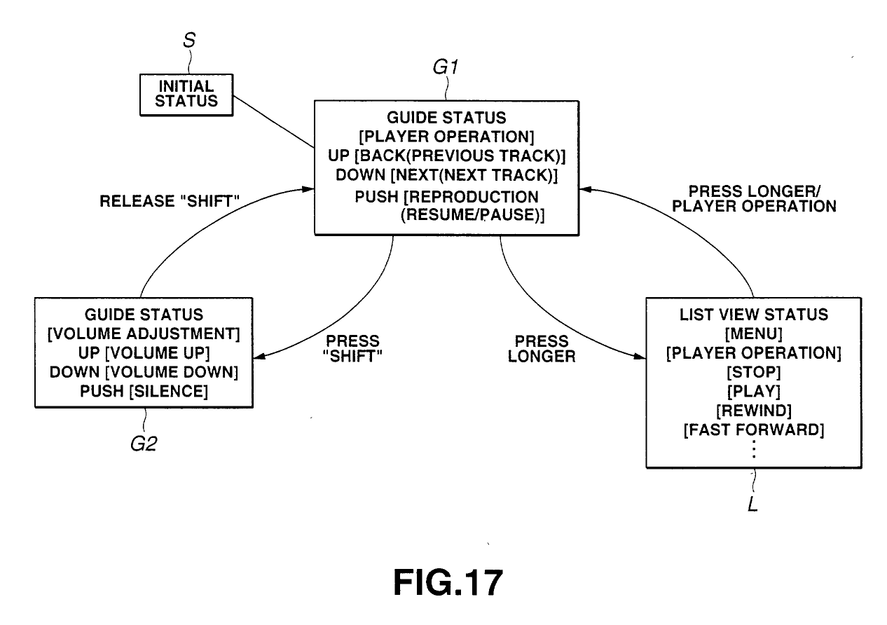

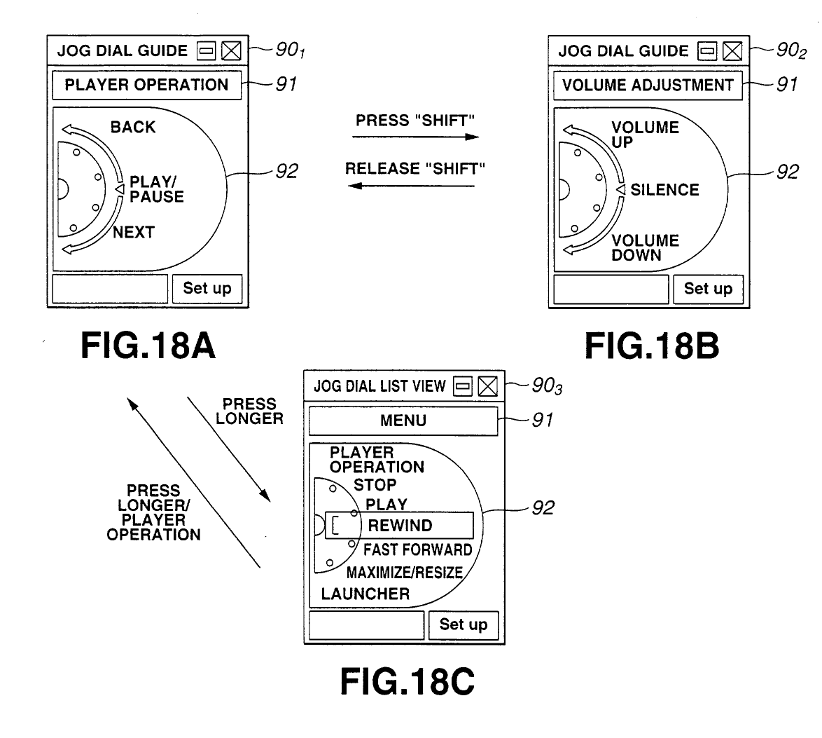

Operations in the case where the notebook model personal computer 1 starts, for example, audio reproduction software as a jog dial-unsupportable application program, will now be described with reference to FIG. 17 and FIGS. 18A to 18C.

FIG. 17 is a state transition view showing a display status which is presented in the jog dial window (GUI) 305 on the LCD 8 as the CPU 51 executes the jog dial driver 54D or the jog dial status monitor program 54C, that is, the jog dial server 303 loads and executes the jog script 301. FIGS. 18A to 18C show examples of the display in the GUI 305.

First, when the audio reproduction software is started, the jog dial server 303 in FIG. 1 loads the script file 301 and displays on the GUI 305 an item related to a guide operation of the audio reproduction software that can be associated with an operation of the jog dial 304 (corresponding to the jog dial 4 in FIG. 2). This is an initial status S.

When the audio reproduction software is started, the first thing the user can do is forward/backward shift of tune and switching of play and pause. Thus, the jog dial server 303 presents a first guide status display in which an upward/downward rotation or turn of the jog dial 4 is associated with the forward/backward shift operation while pressing of the jog dial 4 is associated with the switching of play/pause. Specifically, what the user can do is described as “player operation” in an operation name display part 91 in a guide status display window 90₁ shown in FIG. 18A. Moreover, shift to the previous tune (previous track) is associated with an upward rotation or turn (Up) operation of the jog dial and shift to the next tune (next track) is associated with a downward rotation or turn (Down) operation. Reproduction (resumption/pause) is associated with a press operation of the jog dial 4. These are described in an item display part 92.

If the shift key 10L or 10R is pressed in the first guide status display G1, the display shifts to a second guide status display G2. The second guide status display G2 shows that volume adjustment can be carried out by the jog dial 4 when the shift key (shift key 10L or 10R in FIG. 2) is being pressed. Increase in volume is associated with an upward rotation or turn (Up) operation of the jog dial and decrease in volume is associated with a downward rotation or turn (Down) operation. Silencing is associated with a press operation (Push) of the jog dial 4. A specific display is shown in a guide status display window 90₂, as shown in FIG. 18B. To notify the user of whether the status can shift to the guide status display window 90₂ or not, characters “SHIFT” are displayed in a different color from the other items or caused to flash, in a blank space in a lower left part of the guide status display window 90₁ shown in FIG. 18A. When the shift key is released in the second guide status display G2, the first guide status display G1 is restored.

When the jog dial 4 is pressed longer than, for example, 1 second, in the first guide status display G1, the display shifts to a list view status display L. The list view status display L shows items such as player operation, stop, play, rewind, fast forward, maximize/resize, application end, and launcher. Then, a list view status display window 90₃ shown in FIG. 18C is displayed on the LCD 8. For selecting one of the items from the item display part 92 in the list view status display window 90₃, a selected item is entered in a frame 93 by upward/downward rotations or turns of the jog dial 4 and the selected item is decided by pressing the jog dial 4.

When, in the list view status display L, the jog dial 4 is pressed longer than, for example, 1 second, or a player device is selected and decided by the above-described procedure, the display shifts to the first guide status display G1.

In accordance with the above-described procedures, even when the jog dial-unsupportable audio reproduction application is started, the notebook model personal computer 1 only requires visual confirmation for the first use, and for the second and subsequent uses, it enables the user to intuitively rotate or turn the jog dial 4 upward or downward to carry out audio reproduction. As the shift key 10L or 10R is pressed in this status, the volume can be adjusted by an upward/downward rotation or turn of the jog dial 4 while the shift key is being pressed.

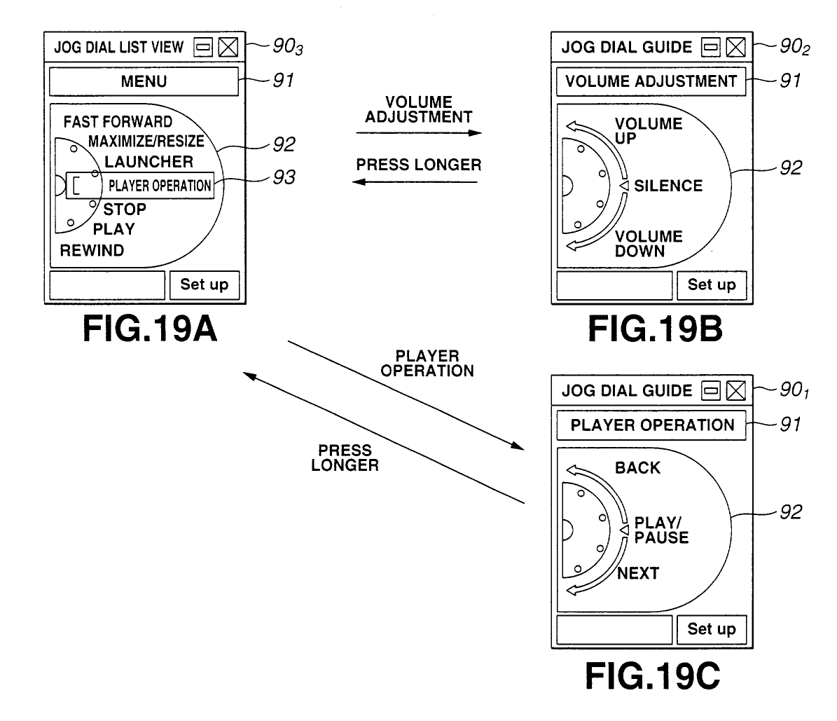

Meanwhile, if the list view status display window 90₃ is displayed as shown in FIG. 19A immediately after the jog dial-unsupportable audio reproduction application is started, it is necessary to confirm each item on the item display part 92 and then operate the jog dial 4. For example, to carry out the player operation, the item of player operation is entered in the frame 93 in the item display part 92, corresponding to an upward/downward rotation or turn operation of the jog dial 4, and then the jog dial 4 is pressed down. This causes the display to shift to the guide status display window 90₁ related to the player operation shown in FIG. 19C. To adjust the volume, volume adjustment must be selected and decided in the list view status display window 90₃ and then the guide status display window 90₂ must be displayed.

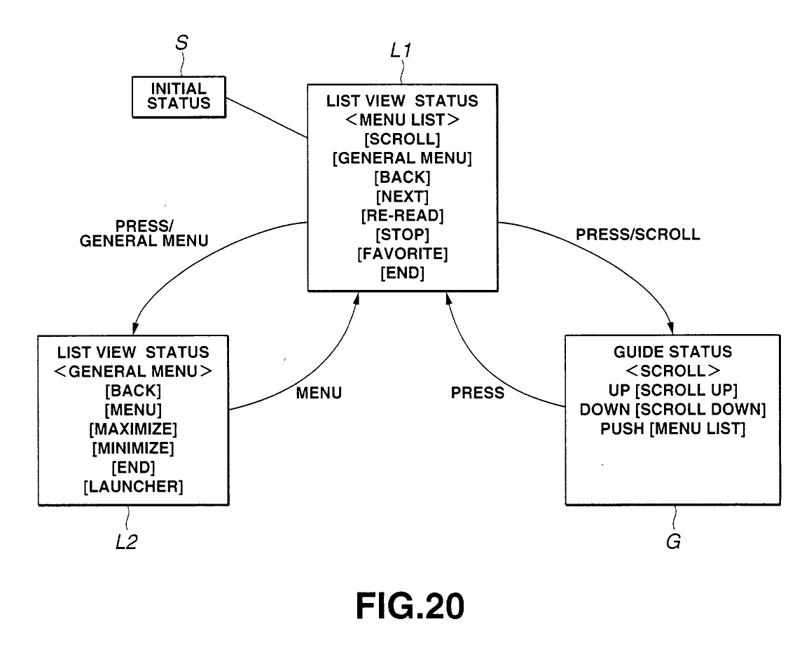

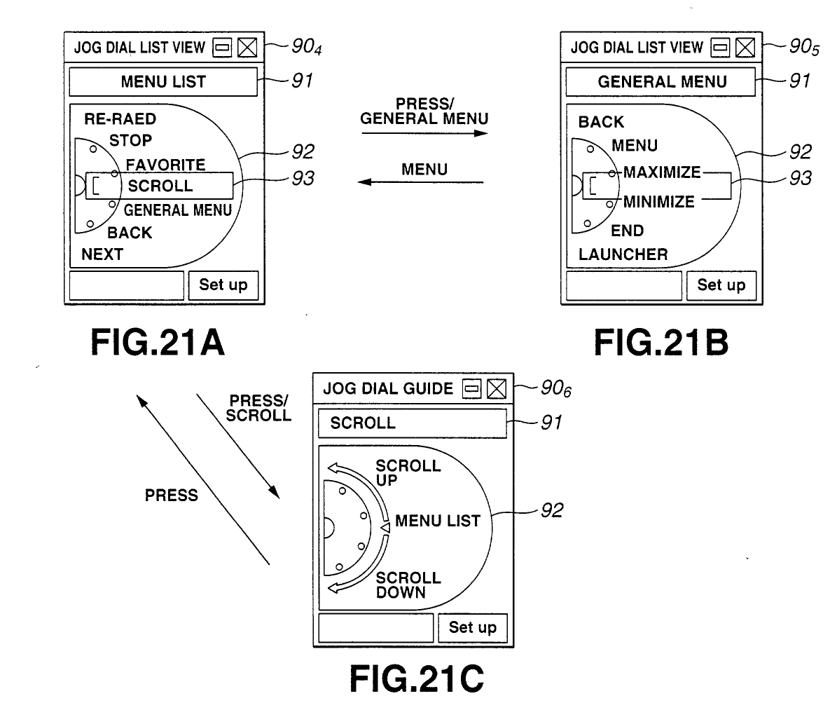

Operations in the case where the notebook model personal computer 1 starts, for example, a browser for the Internet as a jog dial-unsupportable application program, will now be described with reference to FIG. 20 and FIGS. 21A to 21C.

FIG. 20 is a state transition view showing a display status which is presented in the GUI 305 on the LCD 8 as the CPU 51 executes the jog dial driver 54D, that is, the jog dial server 303 loads and executes the jog script 301. FIGS. 21A to 21C show examples of the display in the GUI 305.

First, when the browser is started, the jog dial server 303 in FIG. 1 loads the script file 301 and displays on the GUI 305 an item related to a list view operation of the browser that can be associated with an operation of the jog dial 304. This is an initial status S.

When the browser is started, the first thing the user can do is shift to the previous page in the history, shift to the next page in the history, update of the contents of the same page, or opening of a so-called favorite menu. Thus, the jog dial server 303 uses upward/downward rotations of the jog dial 4 for selection of item names “back”, “next”, “re-read”, “favorite” of the same functions as buttons “back”, “next”, “re-read”, “favorite”. After entering the selected item name in the frame 93, the jog dial server 303 presents a list view status display L1 in order to decide the selected item name by pressing down the jog dial 4. Specifically, what the user can do is described as “menu list” in the operation name display part 91 in a list view status display window 90₄ shown in FIG. 21A, and the above-described item names such as “back”, “next”, “re-read”, “favorite” are described in the item name display part 92. In the list vide status display window 90₄, “scroll” is an item for shifting to a scroll operation display in the guide status display G, which will be described later. “General menu” is an item for shifting to a list view status display window 90₅, which will be described later. “Back” is an item for shifting to the previous page in the history. “Next” is an item for shifting the next page in the history. “Re-read” is an item for updating the contents of the same page. “Stop” is an item for stopping reading of the page. “Favorite” is an item for opening a favorite menu. “End” is an item for ending the browser.

When the jog dial 4 is pressed down or the general menu is selected and decided in the first list view status display L1, the display shifts to a second list view status display L2. The second list view status display L2 is also for displaying “general menu” and displays items such as “back”, “menu”, “maximize”, “minimize”, “end” and “launcher”. “Back” is an item for restoring the menu list status. It is the same in the case of pressing the jog dial 4 long or operating the back button 5. “Menu” is an item for opening a menu held by the application, similar to the case of pressing down the “Alt” key. “Maximize” and “minimize” are items for maximizing and minimizing the window. “End” is an item for ending. “Launcher” is an item for ending the browser.

When the jog dial 4 is pressed down or scroll is selected and decided in the first list view status display L1, the display shifts to the guide status display G. Upward scroll is associated with an upward rotation or turn (Up) operation of the jog dial, and downward scroll is associated with a downward rotation or turn (Down) operation. Shift to the list view status display is associated in a press operation (Push) of the jog dial 4. A specific display is shown in a guide status display window 90₆, as shown in FIG. 21C.

In the above description, for each jog dial-unsupportable application, an operation of the jog dial and an operation of the application are associated with each other by using the script 301. However, systematically similar applications may be grouped as an application group of the same system, for example, a music reproduction-based, image reproduction-based, text input-based, browser-based or electronic mailer-based application group, and operations of the jog dial and operations of the applications may be collectively associated with each other. The music reproduction-based and the image reproduction-based may be grouped as a multimedia reproduction-based application group. Moreover, a scroll-based application group may be set in which operations of applications significantly depend on scroll operations.

With respect to the application group, basic application operations and operations of the jog dial may be associated with each other. For example, in the case of the multimedia-based application group, operations of the jog dial and basic operations can be allocated as described with reference to FIG. 17 and FIGS. 18A to 18C. In the case of the browser-based application group, operations of the jog dial and basic operations can be allocated as described with reference to FIG. 20 and FIGS. 21A to 21C.

For example, the above-described reproduction operation and the volume adjustment operation are applied to all the multimedia-based applications and the same character string display and the same operation are provided in any of these applications. Therefore, the user can easily learn the operating method by experiencing the operations several times. After that, the user can use the applications without seeing the GUI.

Similarly, when a new application appears, a new application name can be registered to the application group.

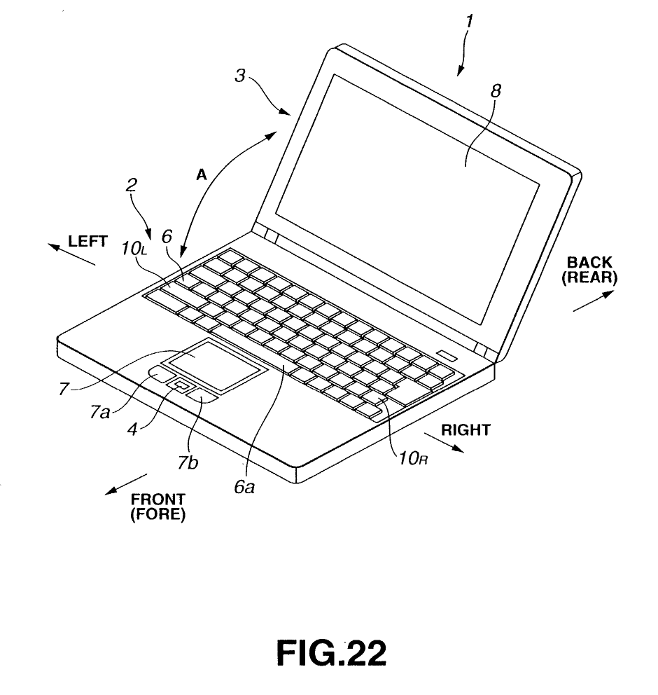

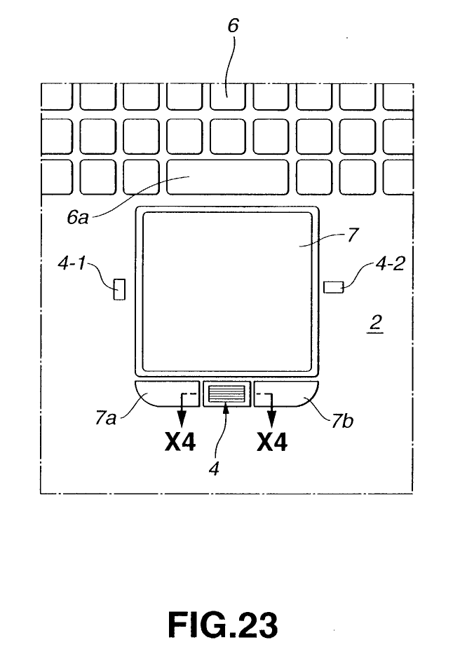

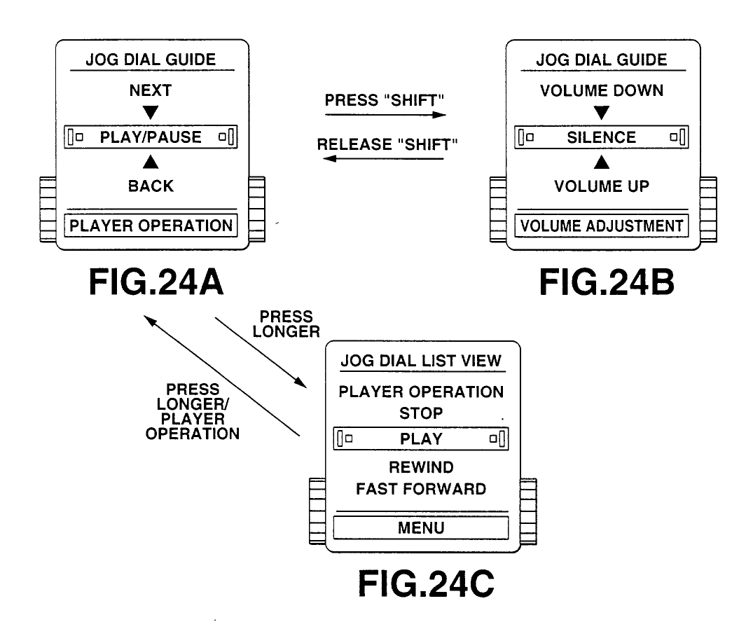

A second specific example of the information processing device will now be described with reference to FIG. 22, FIG. 23 and FIGS. 24A to 24C. Again, this second specific example is a notebook model personal computer 1 as shown in FIG. 22 and executes the information processing method of the present invention by having provided therein or loading therein a recording medium on which the information processing program of the present invention is recorded. However, the second specific example is different from the first specific example in the position where the jog dial 4 is installed. The structure of this notebook model personal computer 1 is schematically the same as the structure of the notebook model personal computer 1 shown in FIG. 1, except that the back button is not provided.

As shown in FIG. 22, on a palm rest, which is on the upper surface of a body 2 and more specifically before a keyboard 6, a touch pad 7 a left click button 7a and a right click button 7b are provided. As shown in detail in FIG. 22, the touch pad 7 is substantially square and is arranged at a position which is substantially middle in the left-and-right direction of the body 2 and closer to the keyboard 6. More specifically, the back line part of the touch pad 7 extending along the front line part of the keyboard 6 is situated near a space key 6a of the keyboard 6, which is used very frequently. The left and right click buttons 7a, 7b are arranged before the touch pad 7 and near the touch pad 7 so that these click buttons are situated substantially in the middle of the left-and-right direction of the body 2. These left and right click buttons 7a, 7b are arranged in series in the left-and-right direction of the body 2. The touch pad 7 is a kind of so-called pointing device, as is already known.

The left click button 7a and the right click button 7b are arranged at a small spacing from each other in the left-and-right direction and a jog dial 4 is provided in the spacing between the left and right click buttons 7a, 7b. In this manner, the left click button 7a, the jog dial 4 and the right click button 7b are arranged in series in the left-and-right direction of the body 2. The jog dial 4 is situated very close to the left and right click buttons 7a, 7b and very close to the touch pad 7.

The jog dial has a rotating member. This rotating member is formed to be elongated and extended in the left-and-right direction of the body 2, and a part of the rotating member protrudes slightly upward from the palm rest. The rotating member is to be rotated forward and backward around an axial line which is set in the left-and-right direction of the body 2 and substantially parallel to the upper surface of the body 2. That is, the rotating member is to be rotated in the front-and-back direction. The rotating member can also be pressed downward. In FIG. 23, members indicated by chain-dotted lines and denoted by 4-1 and 4-2 are associated with the jog dial 4 attached at different positions.

The rotating member of the jog dial 4 basically has three-dimensional displacement elements such as forward rotation, backward rotation, and press down. In addition to these displacement elements, the quantity of rotation in each direction of rotation and the rotation speed based on the calculation of the quantity of rotation can also be provided. In short, a number of different types of operation status of the rotating member are provided and various functions are allocated in accordance with the different types of operation status, thus significantly improving the user-friendliness of the notebook model personal computer 1.

When the user carries out various inputs by using the keyboard 6 with his/her wrists or nearby parts supported on the palm rest, the touch pad 7 and the left and right click buttons 7a, 7b are operated by the user's fingertip. Since the rotating member of the jog dial 4 is near the touch pad 7 and also near the left and right click buttons 7a, 7b, the user need not largely move his/her hand during the input operation using the keyboard 6 and can rotate and press the rotating member, for example, with the tip of his/her forefinger or thumb. Thus, the operability of the rotating member is improved. Moreover, since the rotating member of the jog dial 4 is situated substantially in the middle of the left-and-right direction of the body 2, the operator can operate the rotating member constantly with his/her dominant hand whether the operator is right-handed or left-handed. Therefore, the operability of the rotating member is further improved.

The electric circuit structure in the notebook model personal computer 1 of the second specific example is similar to that of the first specific example shown in FIG. 11 and therefore will not be described further in detail.

Also in the notebook model personal computer 1 of the second specific example, the CPU 51 executes the specific example of the information processing program as described with reference to FIG. 15. The CPU 51 functions as the jog dial server 303 shown in FIG. 1.

Again, an example of processing of the jog dial status monitor program 54C and the jog dial driver 54D executed by the CPU 51, for example, after the guide display status is displayed on the GUI 305 when the notebook model personal computer 1 of the second specific example starts a jog dial-unsupportable application program, is as shown in FIG. 16.

Operations in the case where the notebook model personal computer 1 of the second specific example starts, for example, audio reproduction software as a jog dial-unsupportable application program, are as described above with reference to FIG. 17, and the GUI in this case is as shown in FIGS. 24A to 24C.

First, when audio reproduction software is started, what the user can do is described as “player operation” in a guide status display window shown in FIG. 24A. In this guide status display window, shift to the previous tune (previous track) is associated with an upward rotation (Up) operation of the jog dial and shift to the next tune (next track) is associated with a downward rotation (Down) operation. Reproduction (resumption/pause) is associated with a press operation of the jog dial 4.

If the shift key 10L or 10R is pressed in this first guide status display G1, the display shifts to a second guide status display G2. It is shown in the guide status display window, as shown in FIG. 24B. When the shift key is released in the second guide status display G2, the first guide status display G1 is restored.

When the jog dial 4 is pressed longer than, for example, 1 second, in the first guide status display G1, the display shifts to a list view status display L. The list view status display L shows items such as player operation, stop, play, rewind, fast forward, maximize/resize, application end, and launcher. Then, a list view status display window shown in FIG. 24C is displayed on the LCD 8. For selecting one of the items in the list view status display window, a selected item is entered in a frame by upward/downward rotations of the jog dial 4 and the selected item is decided by pressing the jog dial 4.

When, in the list view status display L, the jog dial 4 is pressed longer than, for example, 1 second, or a player device is selected and decided by the above-described procedure, the display shifts to the first guide status display G1.

In accordance with the above-described procedures, even when the jog dial-unsupportable audio reproduction application is started, the notebook model personal computer 1 of the second specific example only requires visual confirmation for the first use, and for the second and subsequent uses, it enables the user to intuitively rotate the jog dial 4 upward or downward to carry out audio reproduction. As the shift key 10L or 10R is pressed in this status, the volume can be adjusted by an upward/downward rotation of the jog dial 4 while the shift key is being pressed.

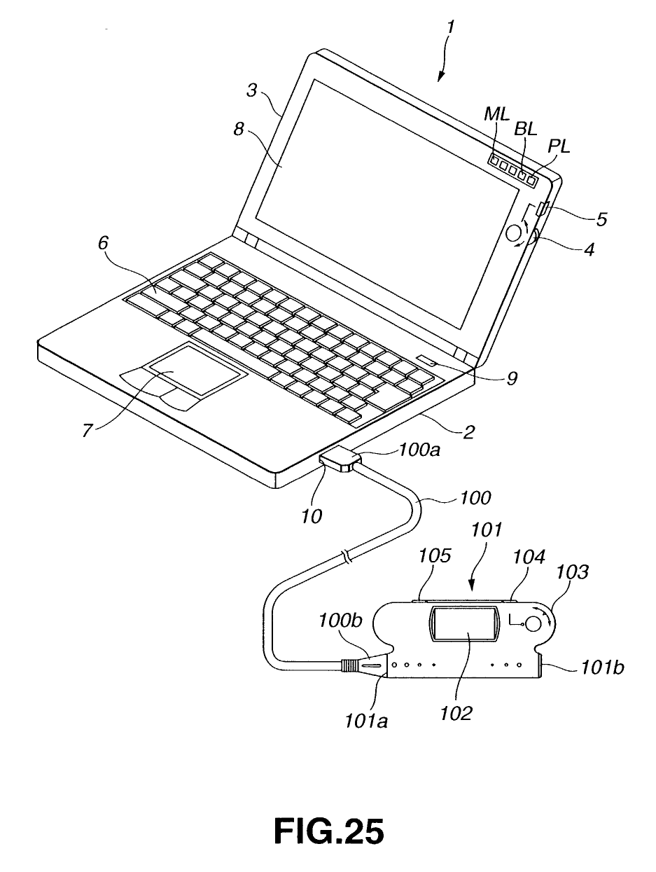

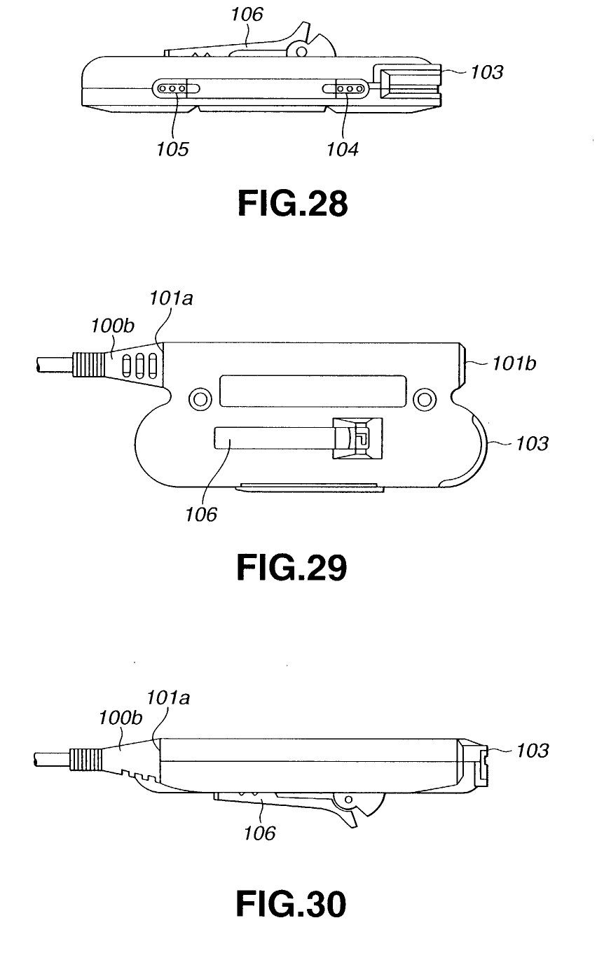

A third specific example of the information processing device will now be described with reference to FIG. 25 to FIGS. 36A to 36C. The third specific example is an information processing system including a notebook model personal computer 1 and a remote operation device 101 connected to a USB (Universal Serial Bus) port 10 of the notebook model personal computer 1 via a USB cable 100, as shown in FIG. 25.

The structure of the notebook model personal computer 1 is the same as the structure described above with reference to FIG. 2 and therefore will not be described further in detail.

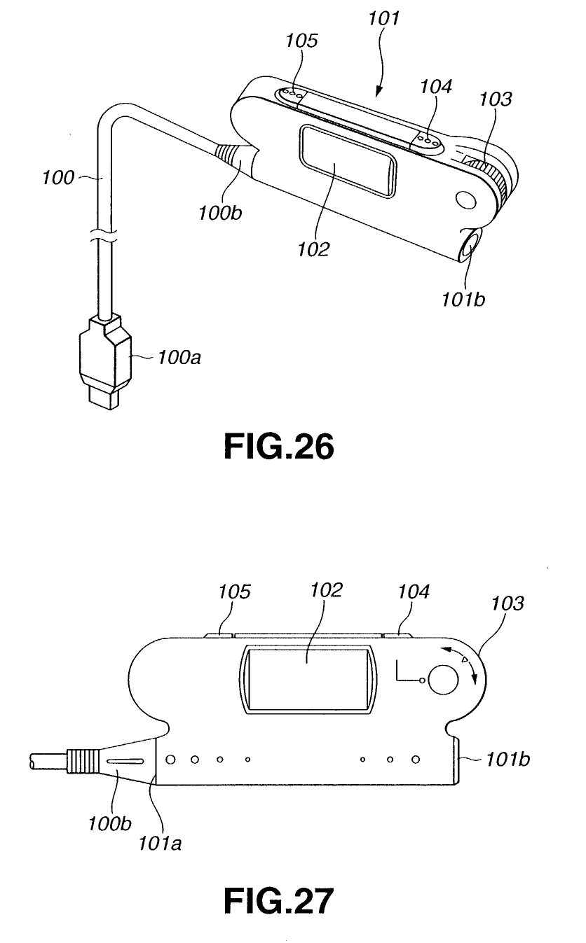

The remote operation device 101, the appearance of which is shown in FIG. 26, is a specific example of information output means for outputting an information signal supplied from the notebook model personal computer 1 via the USB cable 100. An LCD 102 is provided on the front side of the remote operation device 101. A jog dial 103 is provided on the right inclined lateral side of the remote operation device 101, and a back button 104 and a shift button 105 are provided on the top lateral side of the remote operation device 101. Inside the remote operation device 101, control means, which will be described later, is provided for determining the operating status of the jog dial 103, the back button 104 and the shift button 105, then sending the result of determination to the notebook model personal computer 1 and causing the LCD 102 to display an information signal supplied from the notebook model personal computer 1.

In the following description, the remote operation device 101 is referred to as remote controller with jog dial 101, as it is a remote operation device having the jog dial 103 and the like.

At both ends of the remote controller with jog dial 101, connecting parts 101a and 101b are provided. The connecting part 101a is used for connection with the USB cable 100, and the connecting part 101b is used for connection with a headphone, which will be described later.

The USB cable 100 has its connecting part 100b connected with the connecting part 101a of the remote controller with jog dial 101, and has its connecting part 100a inserted in the USB port 10 of the notebook model personal computer 1, thus transmitting the information signal. The connecting part 101a is connected with the connecting part 100b of the USB cable 100 in a fixed manner.

FIGS. 27, 28, 29 and 30 shows the detailed shape of the front side, top side, back side and bottom side of the remote controller with jog dial 101. As shown in FIGS. 27 to 30, a clip 106 is provided on the back side. Using this clip 106, the remote controller with jog dial 101 is attached to the clothes of the operator.

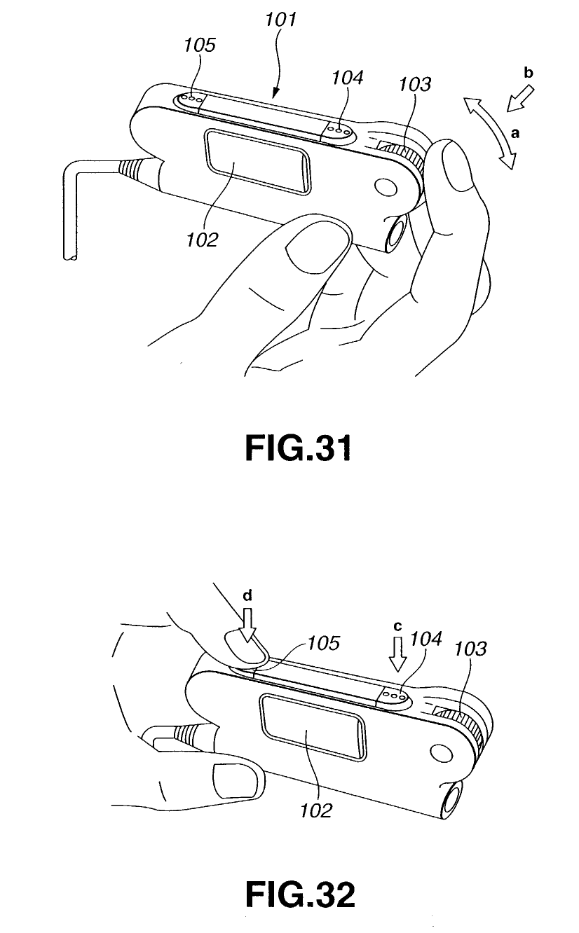

FIGS. 31 and 32 show the operating status of the remote controller with jog dial 101 operated by the operator. The jog dial 103 is rotated in a direction of arrow a and pressed in a direction of arrow b, as shown in FIG. 31. The back button 104 and the shift button 105 are pressed down in directions of arrow c and d. By holding the side of the jog dial 103 with the right hand and holding the side of the shift button 105 with the left hand, the operator can operate the remote controller with jog dial 101 while visually confirming the LCD 102.

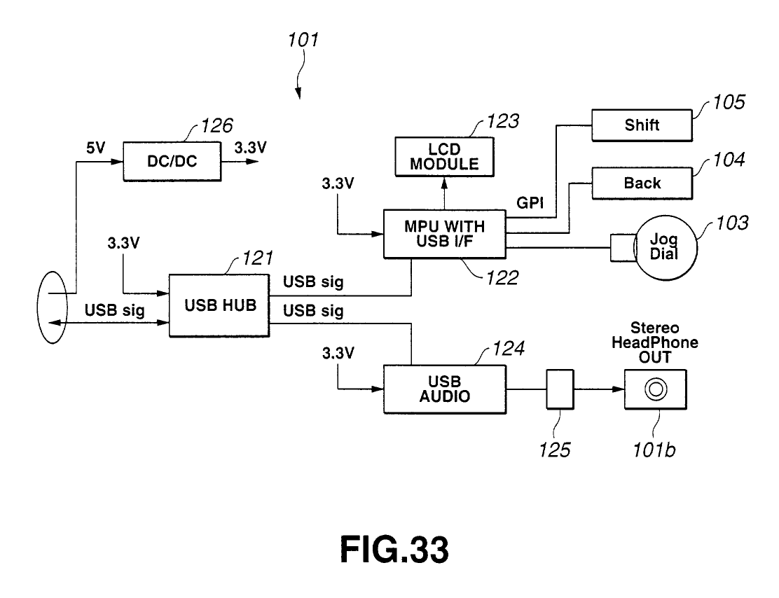

The electrical structure of the remote controller with jog dial 101 will now be described with reference to FIG. 33. In the remote controller with jog dial 101, an input USB signal transmitted from the notebook model personal computer 1 via the USB cable 100 is branched into two USB signals by a USB hub 121, and one of the USB signals is supplied to a microprocessor unit (MPU) 122 having a USB interface (I/F). The other USB signal is supplied to a USB audio signal processing unit 124.

The MPU with USB I/F 122 determines the operating status of the jog dial 103, the back button 104 and the shift button 105, sends the result of determination to the notebook model personal computer 1, and supplies the one USB signal supplied thereto from the notebook model personal computer 1, to an LCD module 123.

The USB audio signal processing unit 124 reproduces the audio signal, which is the other USB signal, and sends it to a headphone amplifier 125. The headphone amplifier 125 amplifies the audio signal and supplies the amplified audio signal from a stereo headphone output terminal (connecting parat 101b) to a headphone. The USB hub 121, the MPU with USB I/F 122 and the USB audio signal processing unit 124 are supplied with a power-supply voltage converted from 5 V to 3.3 V by a DC/DC converter 126.

Since the remote controller with jog dial 101 has the USB audio signal processing unit 124, the user can listen to reproduced sounds of music simply by connecting the headphone with the headphone output terminal 101b.

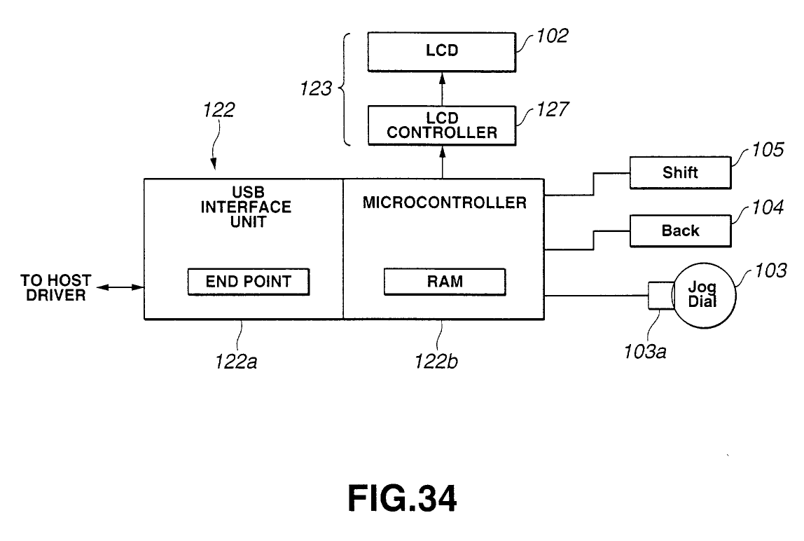

The MPU with USB I/F 122 is constituted by a USB interface unit 122a and a microcontroller 122b, as shown in FIG. 34. The USB interface unit 122a includes an end point. The microcontroller 122b includes a RAM. The microcontroller 122b detects a rotation operation and a press operation (push switch 103a) of the jog dial 103 and press operations of the back button 104 and the shift button 105. The LCD module 123 is constituted by an LCD controller 127 and the LCD 102.

In this information processing system, when the remote controller with jog dial 101 is connected with the notebook model personal computer 1 via the USB cable 100, firmware is transferred from the notebook model personal computer 1 to the remote controller with jog dial 101. Then, the remote controller with jog dial 101 stores the firmware into the RAM, temporarily put in an electrically reset state, and then executes the firmware. The firmware may be related to acquisition of the jog dial and buttons and a method for transfer to the host, or related to a method for drawing onto the LCD and a method for acquiring drawing data, or related to processing in suspension and resumption.

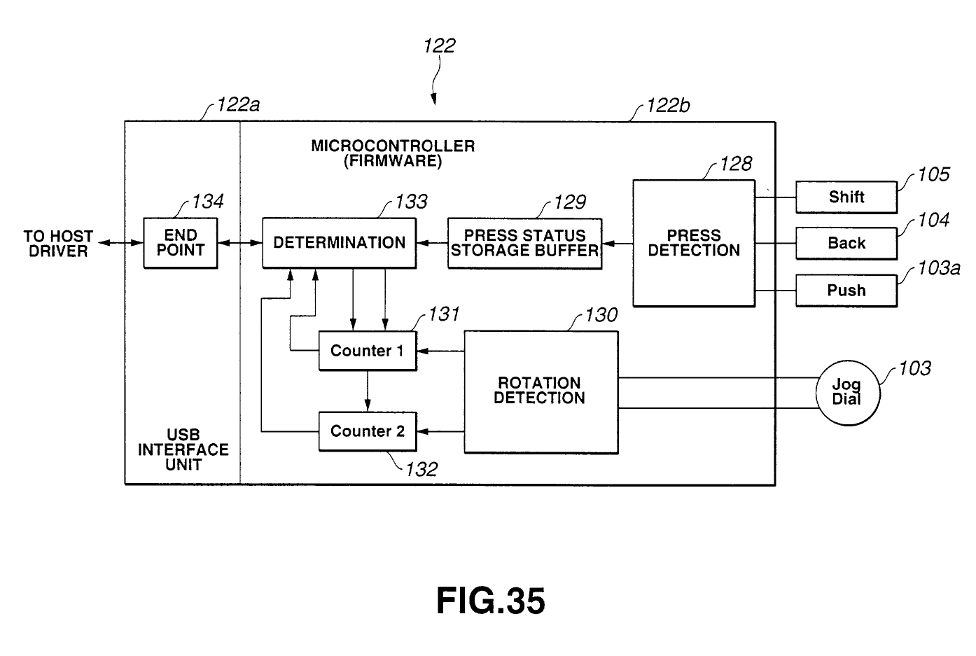

FIG. 35 shows functions inside the microcontroller, as a block diagram. The microcontroller 122b is divided into the functions shown in FIG. 35 by executing the firmware.

First, the firmware detects whether the rotary encoder part of the jog dial is rotated left or right. The signal level thereof is read from the port of the microcontroller 122b and the direction of rotation is led out from a change in the status.

If a left rotation is detected, a left rotation pulse is supplied to a counter (1) 131. Then, the counter (1) 131 increases the left rotation count value by 1. If a right rotation is detected, a right rotation pulse is supplied to a counter (2) 132. Then, the counter (2) 132 increase the right rotation count value by 1.

Next, the firmware reads the press status of the push button 103a of the jog dial 103, the back button 104 and the shift button 105 from the signal level at the port of the microcontroller 122, by using a press detecting unit 128.

The press status is compared with the previous status, and if there is a change in the status (YES), the present status is saved at the last part in a press status storage buffer 129. The purpose of using the buffer 129 is to notify the host drive of changes in the status of the buttons in the order of occurrence of the changes.

Next, using a determining unit 133, the firmware determines whether the host driver acquired the previously sent information or not, on the basis owhether an end point 134 is vacant or not. This is because the host driver sequentially acquires contents set in the end point 134 at constant intervals. If the end point 134 is not vacant, polling is continued.

When the end point 134 is vacant, in order to notify the host driver of the values of the jog dial rotation counters (left and right) and the button press status, the firmware sets data of the counter values and the button press status in the end point 134.

Then, the data which has already been sent to the host driver is cleared. Specifically, the left and right count values of the jog dial rotation counters and the contents at the leading end in the press status storage buffer 129 are erased, and the data is shifted one step before.

Again, in the information processing system of the third specific example, the CPU 51 executes the specific example of the information processing program as described above with reference to FIG. 15. The CPU 51 functions as the jog dial server 303 shown in FIG. 1.

An example of processing of the jog dial status monitor program 54C and the jog dial driver 54D executed by the CPU 51, for example, after the guide display status is displayed on the GUI 305 when the information processing system of the third specific example starts a jog dial-unsupportable application program, is as shown in FIG. 16.

Operations in the case where the information processing system of the third specific example starts, for example, audio reproduction software as a jog dial-unsupportable application program, are as described above with reference to FIG. 17, and the GUI in this case is displayed substantially in the same manner on the LCD 8 of the notebook model personal computer 1 and on the LCD 102 of the remote controller with jog dial 101, or schematically displayed on the side of the remote controller with jog dial 101.

In accordance with the above-described procedures, even when the jog dial-unsupportable audio reproduction application is started, the information processing system of the third specific example only requires visual confirmation for the first use, and for the second and subsequent uses, it enables the user to intuitively rotate the jog dial 103 upward or downward to carry out audio reproduction. As the shift button 105 pressed in this status, the volume can be adjusted by an upward/downward rotation of the jog dial 103 while the shift key is being pressed.

Conventionally, when operating an application on the notebook model personal computer 1 by using a remote controller, the user must read and operate contents that can be operated at present by the jog dial, from a display part provided in the jog dial-equipped machine. Moreover, in the conventional method for displaying on the display part, a plurality of character strings of operation contents that can be selected at present are displayed in a list form so that the user visually confirms these character strings and then rotates and operates the jog dial. Therefore, the user cannot operate the application simply by operating the remote controller at hand.

However, according to the above-described information processing system, the user only need visual confirmation for the first use, and for the second and subsequent uses, the user can operate the application simply by intuitively rotating the jog dial 103 upward and downward.

In this information processing system, though the remote controller with jog dial 101 and the notebook model personal computer 1 are connected with each other by a wire, wireless connection using infrared signals may also be used. In this case, an infrared signal receiving part and an infrared signal transmitting part are provided in both the remote controller with jog dial 101 and the notebook model personal computer 1. Particularly, the wireless connection is very effective for the user to use the application simply by operating the remote controller at hand.

As described above, it is possible to set a scroll-based application group such that operations of applications largely depend on scroll operations. In the present invention, the jog dial server 303 may be provided with a detection function for detecting whether scroll can be used a certain application or not, so as to automatically use the setting of the scroll-based application group. The detection function is made possible as the CPU 51 as the jog dial server 303 determines whether a scroll bar exists in window information of the application or not. When the detection function of the jog dial server 303 recognizes that scroll can be used in the application, it automatically uses the setting of the scroll-based application group, and preferentially displays a scroll guide display status on the GUI when the application is started first. Thus, an optimum operating method for an unknown application can be provided without updating the data of the application group. Similarly, by providing a detection function to detect whether the volume can be adjusted in an application or not, and so on, various unknown applications can be easily handled and the number of maintenance processes such as data updating can be reduced.

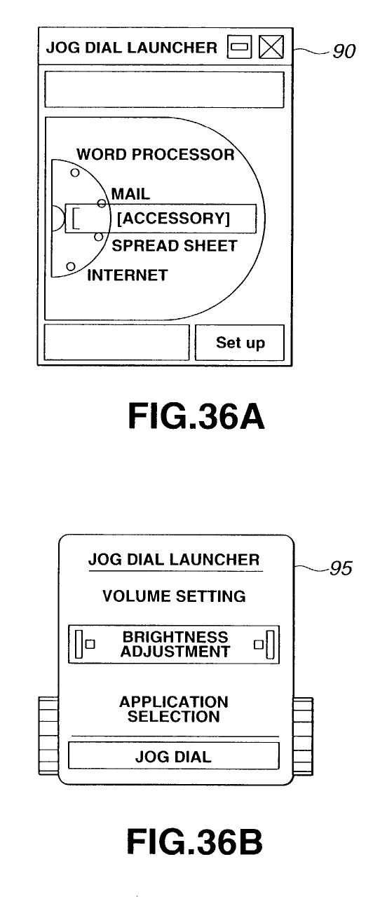

Meanwhile, for example, as an application for personal computers, there is a launcher application which is adapted for the user to register a plurality of applications in advance by himself/herself and select and start an arbitrary one of the applications. Examples of the display on the GUI in the case where the launcher application is started in the notebook model personal computer 1 are shown in FIGS. 36A and 36B. FIG. 36A shows a jog dial launcher window 90 in which applications that can be selected by the jog dial 4 of the notebook model personal computer 1 shown in FIG. 2, that is, “word processor”, “mail”, “accessory”, “spreadsheet” and “Internet”, are displayed. These applications are registered in advance by the user using the launcher application. FIG. 36B shows a jog dial launcher window 95 in which applications that can be selected by the jog dial 4 of the notebook model personal computer 1 shown in FIG. 22, that is, “volume setting”, “brightness adjustment” and “application selection”, are displayed. Again, these applications are registered in advance by the user using the launcher application.

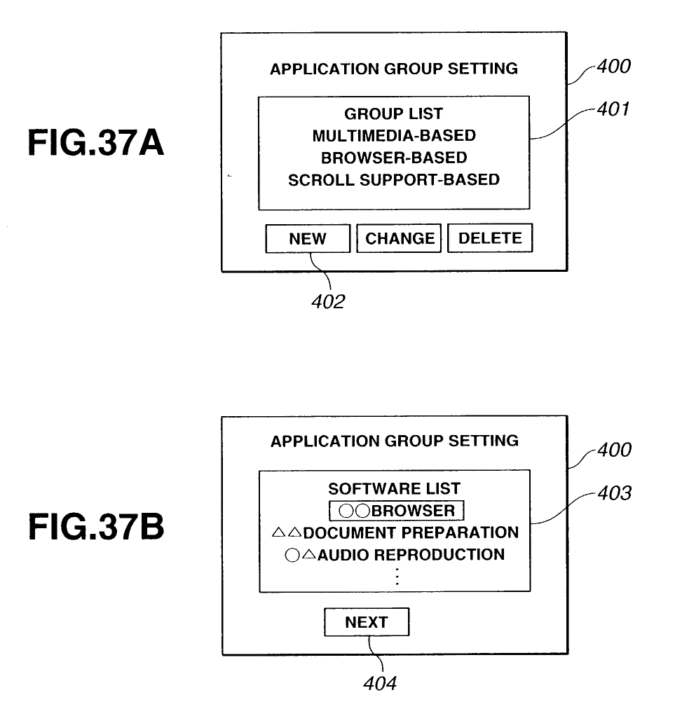

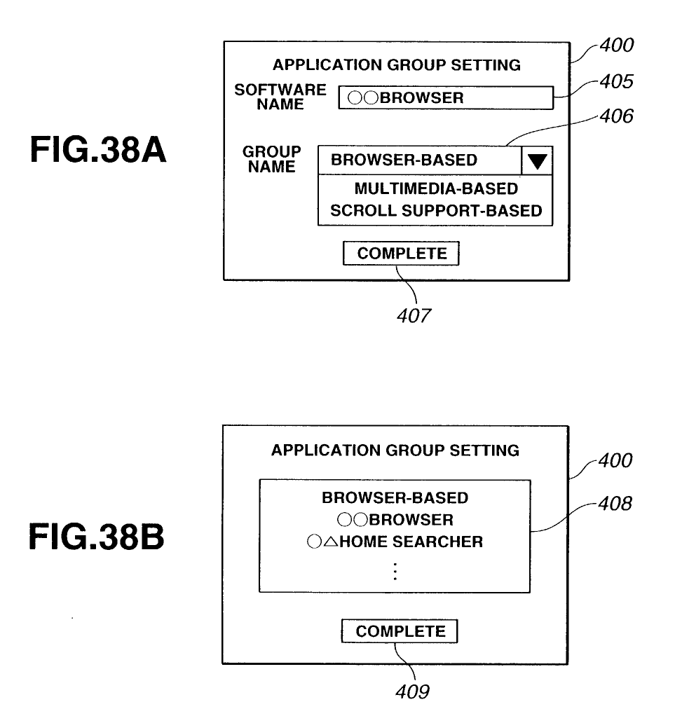

In the present invention, similarly to the launcher application, the user can allowed to set application groups. An item “application group setting” is prepared for each application, and when this item is selected by the user, the notebook model personal computer 1 displays an application group setting dialog 400 as shown in FIG. 37A on the LCD 8. In this application group setting dialog 400, a group list dialog 401 is displayed which shows groups of the same systems such as a multimedia-based group, a browser-based group, and a scroll support-based group. An example of registering a new application to the browser-based group will now be described. First, a “new” button 402 in FIG. 37A is clicked. Then, the notebook model presonal computer 1 displays a software list dialog 403 as shown in FIG. 37B on the LCD 8. If the user now selects “OO browser” and clicks a “next” button 404, the notebook model personal computer 1 displays the dialog 400 on the LCD 8, which shows confirmation items as shown in FIG. 38A. The confirmation items include a software name confirmation item 405 and a group name item 406. As the user presses a “complete” button 407, the “OO browser” is registered to the browser-based group. Finally, the notebook model personal computer 1 displays a browser-based application display dialog 408 shown in FIG. 38B on the LCD 8. If a “complete” button 409 is pressed in this state, the application group setting operation ends.

In this manner, as the user sets an arbitrary application group, the user can register an arbitrary application to the application group without being aware of the jog script.

As described above, according to the embodiment of the present invention, basic elements and functions of an application can be carried out without looking at the screen display. With respect to different applications having similar functions, the user can carry out basic operations simply by knowing the operations of the previous application. Moreover, the operability of a jog dial in an equipment which the user wants to user at hand in a narrow space or a dark place, for example, a jog dial in a remote controller, is improved.

What is claimed is:

1. An information processing device for starting an application program and processing various information, the device comprising:
display means;
first operation means for carrying out rotation or turn and press operations; and
server means for referring to a script defined for interlocking an operation of an unsupportable application program which does not support said first operation means and an operation based on said first operation means;
wherein when said unsupportable application program is started, said server means refers to said script and causes the display means to first display an item related to a basic operation of said unsupportable application program that can be associated with an operation based on said first operation means.

2. The information processing device as claimed in claim 1, wherein said script is loaded to said server means.

3. The information processing device as claimed in claim 1, wherein when said unsupportable application program is started, said server means refers to said script, sets an operation that can be immediately carried out at present by operating said first operation means, and causes said display means to display the item thereof.

4. The information processing device as claimed in claim 1, further comprising second operation means for carrying out a toggle operation, wherein said server means sets an operation that is enabled when said second operation means is operated and said first operation means is operated, with reference to said script, and causes said display means to display the item name thereof.

5. An information processing device for selectively starting a plurality of application programs and processing various information, the device comprising:
display means;
first operation means for carrying out rotation or turn and press operations; and
server means for referring to a script defined for interlocking an operation common to a plurality of unsupportable application programs of the same system which do not support with an operation of said first operation means and an operation based on said first operation means;
wherein when one of said plurality of unsupportable application programs of the same system is started, said server means refers to said script and causes the display means to first display an item related to a basic operation common to said plurality of unsupportable application programs of the same system that can be associated with an operation based on said first operation means.

6. The information processing device as claimed in claim 5, wherein said script is loaded to said server means.

7. The information processing device as claimed in claim 5, wherein when one of said plurality of unsupportable application programs is started, said server means refers to said script, sets a common operation that can be immediately carried out at present by operating said first operation means, and causes said display means to display the item thereof.

8. The information processing device as claimed in claim 5, further comprising second operation means for carrying out a toggle operation, wherein said server means sets a common operation that is enabled when said second operation means is operated and said first operation means is operated, with reference to said script, and causes said display means to display the item name thereof.

9. An information processing system comprising an information processing device for processing various information on the basis of an application program, and a remote operation device for sending a remote operation signal to the information processing device,
said remote operation device comprising first operation means for carrying out rotation or turn and press operations, and control means for determining an operating status of said first operation means by processing based on the program taken in from said information processing device,
said information processing device comprising server means for referring to a script defined for interlocking an operation of an unsupportable application program which does not support said first operation means and an operation based on said first operation means, said server means referring to said script when said unsupportable application program is started and causing display means to first display an item related to a basic operation of said unsupportable application program that can be associated with an operation based on said first operation means.

10. An information processing system comprising an information processing device for selective starting a plurality of application programs and processing various information respectively, and a remote operation device for sending a remote operation signal to the information processing device,
said remote operation device comprising first operation means for carrying out rotation or turn and press operations, and control means for determining an operating status of said first operation means by processing based on the program taken in from said information processing device,
said information processing device comprising server means for referring to a script defined for interlocking an operation common to a plurality of unsupportable application programs of the same system which do not support an operation of said first operation means and an operation based on said first operation means, said server means referring to said script when one of said plurality of unsupportable application programs of the same system is started and causing display means to first display an item related to a basic operation common to said plurality of unsupportable application programs of the same system that can be associated with an operation based on said first operation means.

11. An information processing method used in an information processing device for starting an application program and processing various information, the method comprising:
a script loading step of loading a script defined for interlocking an operation of an unsupportable application program which does not support an operation of first operation means for carrying out rotation or turn and press operations provided in said information processing device, and an operation based on said first operation means; and
a display control step of, when said unsupportable application program is started, referring to the script loaded by said script loading step and causing display means to first display an item related to a basic operation of said unsupportable application program that can be associated with an operation based on said first operation means.

12. Another information processing method used in an information processing device for selectively starting a plurality of application programs and processing various information, the method comprising:
a script loading step of loading a script defined for interlocking an operation common to a plurality of unsupportable application programs of the same system which do not support an operation of first operation means for carrying out rotation or turn and press operations provided in said information processing device, and an operation based on said first operation means; and
a display control step of, when one of said plurality of unsupportable application programs of the same system is started, referring to the script loaded by said script loading step and causing display means to first display an item related to a basic operation common to said plurality of unsupportable application programs that can be associated with an operation based on said first operation means.

13. An information processing program executed in an information processing device for starting an application program and processing various information, the program comprising:
a script loading step of loading a script defined for interlocking an operation of an unsupportable application program which does not support an operation of first operation means for carrying out rotation or turn and press operations provided in said information processing device, and an operation based on said first operation means; and
a display control step of, when said unsupportable application program is started, referring to the script loaded by said script loading step and causing display means to first display an item related to a basic operation of said unsupportable application program that can be associated with an operation based on said first operation means.

14. Another information processing program executed in an information processing device for selectively starting a plurality of application programs and processing various information, the program comprising:
a script loading step of loading a script defined for interlocking an operation common to a plurality of unsupportable application programs of the same system which do not support an operation of first operation means for carrying out rotation or turn and press operations provided in said information processing device, and an operation based on said first operation means; and
a display control step of, when one of said plurality of unsupportable application programs of the same system is started, referring to the script loaded by said script loading step and causing display means to first display an item related to a basic operation common to said plurality of unsupportable application programs that can be associated with an operation based on said first operation means.
